(19) United States
(12) Patent Application Publication
(10) Pub. No.: US 2019/0197435 A1
(43) Pub. Date: Jun. 27, 2019

(54) ESTIMATION METHOD AND APPARATUS

(71) Applicant: FUJITSU LIMITED, Kawasaki-shi (JP)

(72) Inventor: Kenichi KOBAYASHI, Kawasaki (JP)

(73) Assignee: FUJITSU LIMITED, Kawasaki-shi (JP)

(21) Appl. No.: 16/201,062

(22) Filed: Nov. 27, 2018

(30) Foreign Application Priority Data
Dec. 21, 2017 (JP) 2017-244853

(51) Int. Cl. G06N 99/00; G06N 5/02

(52) U.S. Cl. CPC G06N 99/005; G06N 5/022

(57) ABSTRACT

Based on measured data where a first data size is associated with a prediction performance of a model, a first parameter value defining a first prediction performance curve is calculated. A prediction performance within a predetermined range from the first prediction performance curve is sampled multiple times for each of different data sizes, to generate a plurality of sample point sequences, each of which is a sequence of combinations of a data size and a prediction performance. A plurality of second parameter values defining a plurality of second prediction performance curves representing the sample point sequences are calculated, and a plurality of weights are determined by using the second parameter values and the measured data. Variance information indicating variation of a prediction performance of a second data size estimated from the first prediction performance curve is generated by using the second prediction performance curves and the weights.

### CROSS-REFERENCE TO RELATED APPLICATION

This application is based upon and claims the benefit of priority of the prior Japanese Patent Application No. 2017-244853, filed on Dec. 21, 2017, the entire contents of which are incorporated herein by reference.

### FIELD

The embodiments discussed herein relate to an estimation method and an estimation apparatus.

### BACKGROUND

There are cases in which machine learning is performed as computer-based data analysis. In machine learning, training data indicating a number of known cases is inputted to a computer. The computer analyzes the training data and learns a model in which a relationship between a factor (which may be referred to as an explanatory variable or an independent variable) and a result (which may be referred to as an objective variable or a dependent variable) is generalized. By using this learned model, the computer predicts results of unknown cases.

In machine learning, it is preferable that the accuracy of an individual learned model, namely, the capability of accurately predicting results of unknown cases (which may be referred to as a prediction performance), be high. If a larger sample size of training data is used for learning, a model having a higher prediction performance is obtained. However, if a larger sample size of training data is used, more time is needed to learn a model. Thus, progressive sampling has been proposed as a method for efficiently obtaining a model having a practically sufficient prediction performance.

With this progressive sampling, first, a computer learns a model by using a small sample size of training data. Next, by using test data indicating a known case different from the training data, the computer compares a result predicted by the model with the corresponding known result, to evaluate the prediction performance of the learned model. If the prediction performance is not sufficient, the computer learns a model again by using a larger sample size of training data than that of the previous training data. The computer repeats this procedure until a sufficiently high prediction performance is obtained. In this way, the computer is able to avoid using an excessively large sample size of training data. Thus, the computer is able to shorten the time needed to learn a model.

There has also been proposed a prediction performance curve estimation apparatus which estimates a prediction performance curve that indicates a relationship between sample sizes of training data and the corresponding prediction performances by using the measured values of the prediction performances corresponding to small sample sizes of training data. The proposed prediction performance curve estimation apparatus estimates the prediction performances corresponding to larger sample sizes of training data by using the prediction performance curve. The prediction performance curve estimation apparatus performs a regression analysis in view of the nature that a smaller sample size results in a larger error in the prediction performance and a larger sample size results in a smaller error in the prediction performance.

There has also been proposed a statistical learning apparatus directed to when a linear model f(x; θ) defined by an M-dimensional parameter θ is estimated from learning data including an input x and an output y by performing regression analysis. The statistical learning apparatus creates an input x that results in the minimum learning error for learning data. There has also been proposed an evaluation system which obtains the variation range of time-series data about an objective variable, creates, when the variation range is larger than a predetermined threshold, a regression formula by using the objective variable and an explanatory variable, and displays the regression formula.

Japanese Laid-open Patent Publication No. 2017-49674

Japanese Laid-open Patent Publication No. 09-73438

International Publication Pamphlet No. WO2017/037768

Foster Provost, David Jensen and Tim Oates, “Efficient Progressive Sampling”, Proc. of the 5th International Conference on Knowledge Discovery and Data Mining, pp. 23-32, Association for Computing Machinery (ACM), 1999.

When one estimates a prediction performance corresponding to a sample size, there are cases in which he or she also wishes to obtain not only the corresponding expected value on a prediction performance curve calculated by a regression analysis but also variance information that indicates variation from the corresponding expected value. Examples of the variance information in statistical processing include a confidence interval, a prediction interval, a standard deviation, a variance, and a probability distribution. However, a prediction performance curve which indicates a relationship between sample sizes and the respective prediction performances has heteroscedasticity in which the variance of the prediction performance varies depending on the sample size (homoscedasticity is not established). Namely, it is not easy to effectively estimate variance information on a prediction performance curve obtained by a regression analysis. For example, when the variance information is estimated by using a method in which sampling is performed, such as Markov chain Monte Carlo (MCMC) methods, if improvement in estimation accuracy is simply pursued, the number of samples is increased, whereby the computational load is increased.

### SUMMARY

According to one aspect, there is provided an estimation method including: calculating, by a processor, based on measured data in which a first data size is associated with a prediction performance of a model generated by using training data of the first data size, a first parameter value which defines a first prediction performance curve that indicates a relationship between a data size and a prediction performance, sampling, by the processor, a prediction performance within a predetermined range from the first prediction performance curve a plurality of times for each of different data sizes, to generate a plurality of sample point sequences, each of which is a sequence of combinations of a data size and a prediction performance, calculating, by the processor, a plurality of second parameter values which defines a plurality of second prediction performance curves that represents the plurality of sample point sequences and determining a plurality of weights associated with the plurality of second prediction performance curves by using the plurality of second parameter values and the measured data, and generating, by the processor, variance information which indicates variation of a prediction performance of a second data size estimated from the first prediction performance curve by using the plurality of second prediction performance curves and the plurality of weights.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an estimation apparatus according to a first embodiment;

FIG. 2 is a block diagram illustrating a hardware example of a machine learning apparatus;

FIG. 3 is a graph illustrating an example of a relationship example between sample sizes and prediction performances;

FIG. 4 is a graph illustrating an example of a relationship between learning time and prediction performances;

FIG. 5 illustrates an example of use of a plurality of machine learning algorithms;

FIG. 6 is a graph illustrating an example of a distribution of prediction performances;

FIG. 7 is a graph illustrating an example of a relationship between sample sizes and losses;

FIG. 8 illustrates an example of a first confidence interval calculation method;

FIG. 9 illustrates an example of a second confidence interval calculation method;

FIG. 10 illustrates an example of a third confidence interval calculation method;

FIG. 11 is a block diagram illustrating a functional example of the machine learning apparatus;

FIG. 12 illustrates an example of a management table;

FIG. 13 is a block diagram illustrating a functional example of a performance improvement amount estimation unit;

FIG. 14 is the first half of a flowchart illustrating an example of a procedure of machine learning;

FIG. 15 is the second half of the flowchart illustrating the example of the procedure of the machine learning;

FIG. 16 is a flowchart illustrating an example of a procedure of step execution;

FIG. 17 is a flowchart illustrating an example of a procedure of time estimation;

FIG. 18 is the first half of a flowchart illustrating an example of a procedure of estimation of a performance improvement amount; and

FIG. 19 is the second half of the flowchart illustrating the example of the procedure of the estimation of the performance improvement amount.

### DESCRIPTION OF EMBODIMENTS

Embodiments will be described below with reference to the accompanying drawings, wherein like reference characters refer to like elements throughout.

### First Embodiment

A first embodiment will be described.

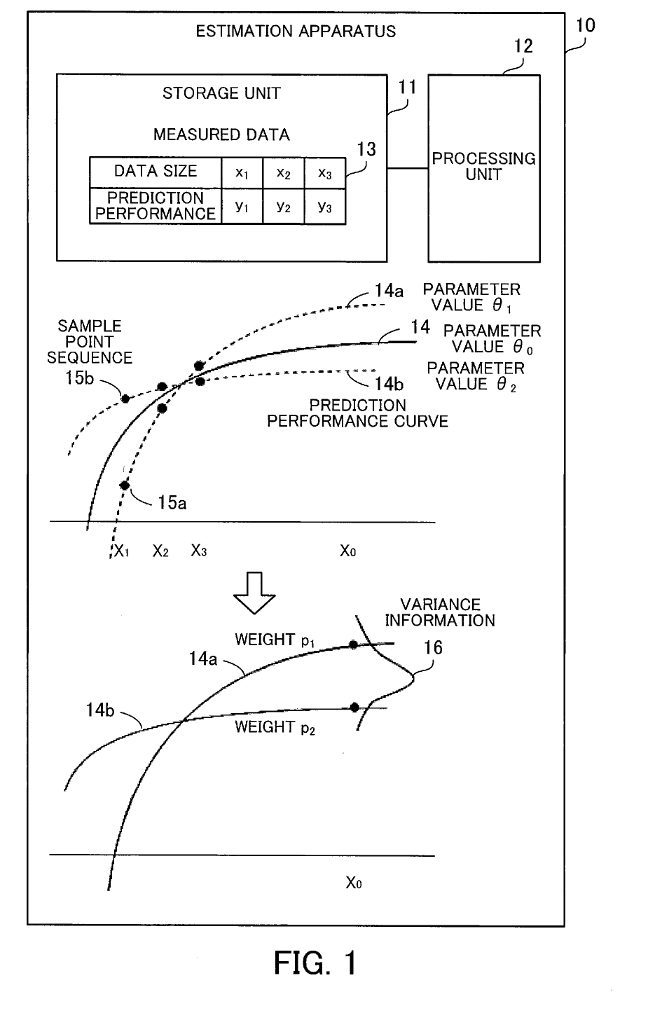

FIG. 1 illustrates an estimation apparatus according to a first embodiment.

This estimation apparatus 10 according to the first embodiment estimates a prediction performance curve which indicates a relationship between data sizes of training data used for machine learning and prediction performances of a model generated by the machine learning. The estimation apparatus 10 may be a client apparatus operated by a user or a server apparatus. The estimation apparatus 10 may be implemented by using a computer.

The estimation apparatus 10 includes a storage unit 11 and a processing unit 12. The storage unit 11 may be a volatile semiconductor memory such as a random access memory (RAM) or a non-volatile storage such as a hard disk drive (HDD) or a flash memory. The processing unit 12 is, for example, a processor such as a central processing unit (CPU) or a digital signal processor (DSP). However, the processing unit 12 may include an electronic circuit for specific use such as an application specific integrated circuit (ASIC) or a field programmable gate array (FPGA). The processor executes programs held in a memory such as a RAM (the storage unit 11, for example). The programs include an estimation program. A group of processors may be referred to as a “multiprocessor” or simply a “processor”.

The storage unit 11 holds measured data 13. In the measured data 13, the data sizes of training data (which will be referred to as “sample sizes” as needed) are associated with prediction performances measured from a model generated by using the training data. In the measured data 13, a plurality of different data sizes are associated with a plurality of prediction performances. For example, in the measured data 13, data sizes x₁ to x₃ are associated with prediction performances y₁ to y₃, respectively. To generate the model, various kinds of machine learning algorithms may be used such as a logistic regression analysis, a support vector machine, and a random forest. The individual prediction performance is the capability of accurately predicting results of unknown cases and may be referred to as “accuracy”. Examples of the index of the prediction performance include accuracy, precision, mean square error (MSE), and root mean square error (RMSE).

The processing unit 12 calculates a parameter value θ₀ which defines a prediction performance curve 14 that indicates a relationship between data sizes and prediction performances based on the measured data 13. The parameter value θ₀ is an adjustable parameter value included in a predetermined mathematical formula indicating the prediction performance curve and is learned by using the measured data 13. The prediction performance curve 14 is the most probable prediction performance curve under the measured data 13. The processing unit 12 is able to calculate the parameter value θ₀ which defines the prediction performance curve 14 from the measured data 13 by performing a regression analysis (for example, a non-linear regression analysis).

Next, the processing unit 12 samples a prediction performance within a predetermined range from a point (an expected prediction performance value) on the prediction performance curve 14 for each of the different data sizes. The width of the predetermined range may vary depending on the data size. For example, the width of the sampling range is determined from the parameter value θ₀ that defines the prediction performance curve 14 and the data size. It is preferable that a wider sampling range be set for a smaller data size and a narrower sampling range be set for a larger data size. For example, the sampling is uniform sampling or systematic sampling within the predetermined range.

The processing unit 12 selects a prediction performance for each of a plurality of data sizes, to generate a sample point sequence, which is a sequence of combinations (points) of a data size and a prediction performance. By repeating this sampling a plurality of times, the processing unit 12 generates a plurality of sample point sequences. The plurality of sample point sequences are located around the prediction performance curve 14. For example, the processing unit 12 generates a plurality of sample point sequences including sample point sequences 15a and 15b.

Next, the processing unit 12 calculates a plurality of parameter values which define a plurality of prediction performance curves that represent the plurality of sample point sequences. For example, the processing unit 12 calculates parameter values θ₁ and θ₂ which define prediction performance curves 14a and 14b that represent the sample point sequences 15a and 15b, respectively. A prediction performance curve corresponding to a sample point sequence includes an error of the prediction performance curve 14 and is located around the prediction performance curve 14. Depending on the number of points included in a sample point sequence, a single prediction performance curve that passes through all points could be derived from a single sample point sequence. The processing unit 12 may calculate a parameter value analytically from a mathematical formula which represents the corresponding prediction performance curve or calculate a parameter value which best describes the corresponding sample point sequence by performing a regression analysis.

Next, the processing unit 12 determines a plurality of weights associated with the plurality of prediction performance curves including the prediction performance curves 14a and 14b, by using the plurality of parameter values inducing the parameter values θ₁ and θ₂ and the measured data 13. For example, the processing unit 12 determines a weight p₁ associated with the prediction performance curve 14a from the parameter value θ₁ and the measured data 13 and determines a weight p₂ associated with the prediction performance curve 14b from the parameter value θ₂ and the measured data 13. The prediction performance curve 14 may be included in or omitted from the plurality of prediction performance curves which the processing unit 12 determines a plurality of weights in association with.

The weight of a prediction performance curve is calculated, for example, by using an occurrence probability that a certain parameter value is observed under the measured data 13. The occurrence probability of a certain parameter value under the measured data 13 is defined, for example, as a likelihood function or a posterior probability. The likelihood function and the posterior probability may be calculated by a predetermined mathematical formula based on the corresponding parameter value and the measured data 13. As a result, a plurality of prediction performance curves including errors around a prediction performance curve are generated, and weights associated with the respective prediction performance curves are determined.

Next, by using the plurality of prediction performance curves and the plurality of weights, the processing unit 12 generates variance information 16 which indicates the variation of a prediction performance that is estimated from the prediction performance curve 14 and that corresponds to a data size x₀. The variance information 16 indicates the prediction performance variation from a point (an expected value) which is on the prediction performance curve 14 and which corresponds to the data size x₀. Even when the same prediction performance curve 14 is used, the reliability of an expected value on the prediction performance curve 14 varies depending on the measured data 13 used to generate this prediction performance curve 14. The reliability of an expected value on the prediction performance curve 14 also varies depending on the data size. Any one of various kinds of statistical processing index may be used as the variance information 16. For example, a confidence interval, a prediction interval, a standard deviation, a variance, or a probability distribution may be used.

For example, by assigning the data size x₀ to each of the plurality of prediction performance curves including the prediction performance curves 14a and 14b, the processing unit 12 calculates a plurality of estimated values corresponding to the data size x₀. These estimated values are weighted estimated values. The processing unit generates the variance information 16 by deeming the plurality of weighted estimated values as a probability distribution. For example, the processing unit 12 calculates a cumulative weight in which weights have been cumulated in ascending order of prediction performance and considers a section from where the prediction performance whose cumulated weight is 2.5% to where the prediction performance whose cumulated weight is 97.5% to be a 95% confidence interval.

The estimation apparatus 10 according to the first embodiment calculates the parameter value θ₀ which defines the prediction performance curve 14 based on the measured data 13. By sampling the prediction performances within an individual predetermined range from the prediction performance curve 14 for each of the different data sizes, the processing unit 12 generates the sample point sequences 15a and 15b. The processing unit 12 calculates the parameter values θ₁ and θ₂ which define the prediction performance curves 14a and 14b that represent the sample point sequences 15a and 15b and determines the weight p₁ and p₂ associated with the prediction performance curves 14a and 14b by using the parameter values θ₁ and θ₂ and the measured data 13. By using the prediction performance curves 14a and 14b and the weights p₁ and p₂, the processing unit 12 generates the variance information which indicates the variation of a prediction performance that is estimated from the prediction performance curve 14 and that corresponds to the data size x₀.

In this way, even when the prediction performance curve 14 has heteroscedasticity in which the variance of a prediction performance varies depending on the data size (even when homoscedasticity is not established), it is possible to estimate the variance information 16 efficiently and accurately. According to the first embodiment, since weighted sampling is performed, a smaller number of samples is needed, compared with the number of samples needed when simple sampling is performed without using any weights. Thus, it is possible to reduce the computational load and shorten the calculation time. In addition, according to the first embodiment, prediction performances are sampled around the prediction performance curve 14, and the sample point sequences 15a and 15b are converted into the parameter values θ₁ and θ₂. Thus, compared with a method in which parameter values are directly sampled around the parameter value θ₀, selection of appropriate parameter values useful for generation of the variance information 16 is easier. Therefore, it is possible to estimate the variance information 16 accurately and set an appropriate number as the number of samples easily.

### Second Embodiment

Next, a second embodiment will be described.

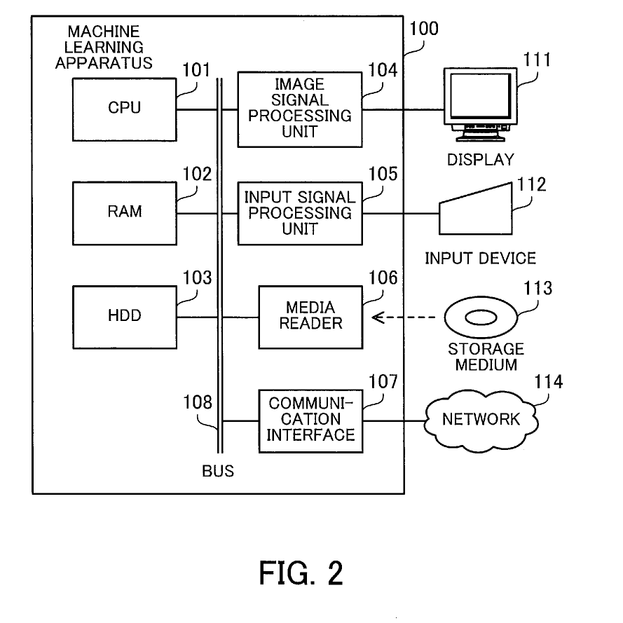

FIG. 2 is a block diagram illustrating a hardware example of a machine learning apparatus.

This machine learning apparatus 100 includes a CPU 101, a RAM 102, an HDD 103, an image signal processing unit 104, an input signal processing unit 105, a media reader 106, and a communication interface 107. These units are connected to a bus 108. The machine learning apparatus 100 corresponds to the estimation apparatus 10 according to the first embodiment. The CPU 101 corresponds to the processing unit 12 according to the first embodiment. The RAM 102 or the HDD 103 corresponds to the storage unit 11 according to the first embodiment.

The CPU 101 is a processor which includes an arithmetic circuit that executes program commands. The CPU 101 loads at least a part of programs or data held in the HDD 103 to the RAM 102 and executes a program. The CPU 101 may include a plurality of processor cores, and the machine learning apparatus 100 may include a plurality of processors. The processing described below may be executed in parallel by using a plurality of processors or processor cores. A group of processors (multiprocessor) may be referred to as a “processor”.

The RAM 102 is a volatile semiconductor memory that temporarily holds a program executed by the CPU 101 or data used by the CPU 101 for calculation. The machine learning apparatus 100 may include a different kind of memory other than a RAM. The machine learning apparatus 100 may include a plurality of memories.

The HDD 103 is a non-volatile storage device that holds data and software programs such as an operating system (OS), middleware, and application software. The programs include a comparison program. The machine learning apparatus 100 may include a different kind of storage device such as a flash memory or a solid state drive (SSD). The machine learning apparatus 100 may include a plurality of non-volatile storage devices.

The image signal processing unit 104 outputs images to a display 111 connected to the machine learning apparatus 100 in accordance with instructions from the CPU 101. Examples of the display 111 include a cathode ray tube (CRT) display, a liquid crystal display (LCD), a plasma display panel (PDP), and an organic electro-luminescence (OEL) display.

The input signal processing unit 105 acquires an input signal from an input device 112 connected to the machine learning apparatus 100 and outputs the input signal to the CPU 101. Examples of the input device 112 include a pointing device such as a mouse, a touch panel, a touch pad, or a trackball, a keyboard, a remote controller, and a button switch. A plurality of kinds of input devices may be connected to the machine learning apparatus 100.

The media reader 106 is a reading device that reads programs or data recorded in a storage medium 113. Examples of the storage medium 113 include a magnetic disk such as a flexible disk (FD) or an HDD, an optical disc such as a compact disc (CD) or a digital versatile disc (DVD), a magneto-optical disk (MO), and a semiconductor memory. For example, the media reader 106 stores a program or data read from the storage medium 113 in the RAM 102 or the HDD 103.

The communication interface 107 is an interface that is connected to a network 114 and that communicates with other apparatuses via the network 114. The communication interface 107 may be a wired communication interface connected to a communication device such as a switch via a cable or may be a wireless communication interface connected to a base station via a wireless link.

The following description will be made on a relationship among a sample size, a prediction performance, and learning time in machine learning and on progressive sampling.

In the machine learning according to the second embodiment, data including a plurality of unit data indicating known cases is collected in advance. The machine learning apparatus 100 or a different information processing apparatus may collect the data from various kinds of devices such as sensor devices via the network 114. The collected data may be large-size data called “big data”. Normally, each unit data includes at least one explanatory variable and at least one objective variable. For example, in machine learning for predicting a commodity demand, result data including a factor that affects the product demand such as the temperature or the humidity as the explanatory variable and a product demand amount as the objective variable is collected.

The machine learning apparatus 100 samples some of the unit data in the collected data as training data and learns a model by using the training data. The model indicates a relationship between explanatory and objective variables and normally includes at least one explanatory variable, at least one coefficient, and one objective variable. For example, the model may be represented by any one of various kinds of mathematical formulas such as a linear expression, a polynomial of degree 2 or more, an exponential function, or a logarithmic function. The form of the mathematical formula may be specified by the user before the machine learning. The coefficient is determined on the basis of the training data in the machine learning.

By using a learned model, the machine learning apparatus 100 predicts the value (result) of the objective variable corresponding to an unknown case from the value (factor) of the explanatory variable corresponding to the unknown case. For example, the machine learning apparatus 100 predicts a product demand amount in the next term from the weather forecast in the next term. The result predicted by a model may be a continuous value such as a probability value expressed from 0 to 1 or a discrete value such as a binary value expressed by YES or NO.

The machine learning apparatus 100 calculates the “prediction performance” of a learned model. The prediction performance is the capability of accurately predicting results of unknown cases and may be referred to as “accuracy”. The machine learning apparatus 100 samples unit data other than the training data from the collected data as test data and calculates the prediction performance by using the test data. The size of the test data is about half the size of the training data, for example. The machine learning apparatus 100 inputs the values of the explanatory variables included in the test data to the model and compares the values (predicted values) of the objective variables that the model outputs with the values (result values) of the objective variables included in the test data. Hereinafter, evaluating the prediction performance of a learned model will be referred to as “validation”, as needed.

The accuracy, precision, MSE, RMSE, or the like may be used as the index of the prediction performance. For example, the following description assumes that the result is represented by a binary value indicating YES or NO. In addition, the following description assumes that, among the cases represented by N₁ test data, the number of cases in which the predicted value is YES and the result value is YES is Tp and the number of cases in which the predicted value is YES and the result value is NO is Fp. In addition, the following description assumes that the number of cases in which the predicted value is NO and the result value is YES is Fn, and the number of cases in which the predicted value is NO and the result value is NO is Tn. In this case, the accuracy is represented by the percentage of accurate predictions and is calculated by (Tp+Tn)/N₁. The precision is represented by the probability of correctly predicting “YES” and is calculated by Tp/(Tp+Fp). If the result value and the predicted value of an individual case are represented by y and ŷ, the MSE is calculated by sum(y−ŷ)²/N₁, and the RMES is calculated by (sum(y−ŷ)²/N₁)^{1/2}. The MSE is equal to the RMSE².

When a single machine learning algorithm is used, if more unit data (a larger sample size) is sampled as the training data, a better prediction performance is achieved.

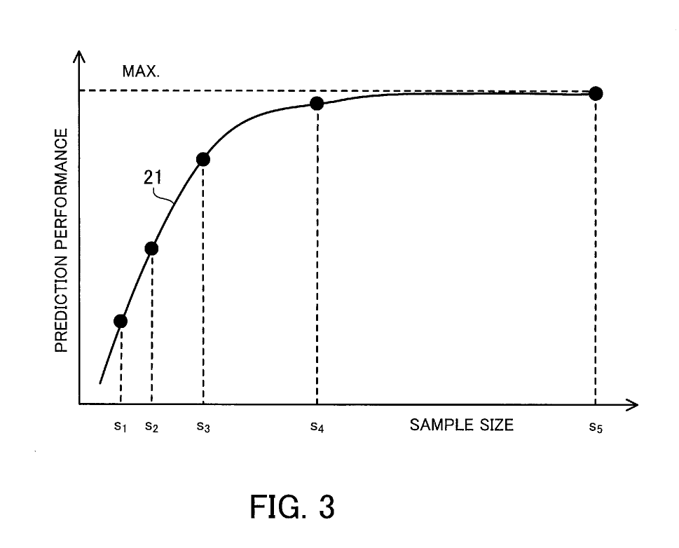

FIG. 3 is a graph illustrating an example of a relationship between sample sizes and prediction performances.

A curve 21 illustrates a relationship between the prediction performances of a model and the corresponding sample sizes. Sample sizes s₁ to s₅ have a size relationship of s₁<s₂<s₃<s₄<s₅. For example, s₂ is twice or four times s₁, and s₃ is twice or four times s₂. In addition, s₄ is twice or four times s₃, and s₅ is twice or four times s₄.

As illustrated by the curve 21, the prediction performance obtained when the sample size is s₂ tends to be higher than that obtained when the sample size is s₁. The prediction performance obtained when the sample size is s₃ tends to be higher than that obtained when the sample size is s₂. The prediction performance obtained when the sample size is s₄ tends to be higher than that obtained when the sample size is s₃. The prediction performance obtained when the sample size is s₅ tends to be higher than that obtained when the sample size is s₄. Namely, if a larger sample size is used, a higher prediction performance tends to be obtained. While the prediction performance is at a low level, the prediction performance largely increases as the sample size increases. However, there is the maximum prediction performance level, and as the prediction performance comes close to its maximum level, the ratio of the increase amount of the prediction performance with respect to the increase amount of the sample size is gradually decreased.

In addition, if a larger sample size is used, more learning time tends to be needed for the machine learning. Thus, if the sample size is excessively increased, the machine learning will be ineffective in terms of the learning time. In the example in FIG. 3, if the sample size s₄ is used, the prediction performance that is close to its maximum level is achieved within a short time. However, if the sample size s₃ is used, the prediction performance could be insufficient. If the sample size s₅ is used, the prediction performance comes close to its maximum level. However, since the increase amount of the prediction performance per unit learning time is small, the machine learning will be ineffective.

This relationship between the sample sizes and the prediction performances varies depending on the nature of the data (the kind of the data) to be used, even when the same machine learning algorithm is used. Thus, it is difficult to previously estimate the minimum sample size with which the maximum prediction performance or a prediction performance close thereto is achieved before performing the machine learning. Thus, a machine learning method referred to as progressive sampling has been proposed. For example, the above document (“Efficient Progressive Sampling”) discusses progressive sampling.

In progressive sampling, a small sample size is used at first, and the sample size is increased step by step. The machine learning is repeatedly performed until the prediction performance satisfies a predetermined condition. For example, the machine learning apparatus 100 performs machine learning by using the sample size s₁ and evaluates the prediction performance of the learned model. If the prediction performance is insufficient, the machine learning apparatus 100 performs machine learning by using the sample size s₂ and evaluates the prediction performance of the learned model. The training data of the sample size s₂ may partially or entirely include the training data of the sample size s₁ (the previously used training data). Likewise, the machine learning apparatus 100 performs machine learning by using the sample sizes s₃ and s₄ and evaluates the prediction performances of the learned models. If the machine learning apparatus 100 obtains a sufficient prediction performance by using the sample size s₄, the machine learning apparatus 100 stops the machine learning and adopts the model learned by using the sample size s₄.

As described above, in progressive sampling, a model is learned, and the prediction performance thereof is evaluated per processing (a single learning step) on a single sample size. Examples of the procedure (the validation method) in an individual learning step include cross validation and random sub-sampling validation.

In cross validation, the machine learning apparatus 100 divides the sampled data into K blocks (K is an integer of 2 or more). The machine learning apparatus 100 uses (K−1) blocks as the training data and 1 block as the test data. The machine learning apparatus 100 repeatedly performs learning of a model and evaluation of the prediction performance K times while changing the block used as the test data. As a result of a single learning step, for example, the machine learning apparatus 100 outputs a model indicating the highest prediction performance among the K models and an average value of the K prediction performances. Cross validation enables evaluation of an individual prediction performance with a limited amount of data.

In random sub-sampling validation, the machine learning apparatus 100 randomly samples training data and test data from a data population, learns a model by using the training data, and calculates the prediction performance of the model by using the test data. The machine learning apparatus 100 repeatedly performs the sampling, the learning of a model, and the evaluation of the prediction performance K times.

Each sampling operation is a sampling operation without replacement. Namely, in a single sampling operation, the same unit data is not included in the training data redundantly, and the same unit data is not included in the test data redundantly. In addition, in a single sampling operation, the same unit data is not included in the training data and the test data redundantly. However, in the K sampling operations, the same unit data may be selected. As a result of a single learning step, for example, the machine learning apparatus 100 outputs a model indicating the highest prediction performance among the K models and an average value of the K prediction performances.

There are various procedures (machine learning algorithms) for learning a model from training data. The machine learning apparatus 100 is able to use a plurality of machine learning algorithms. The machine learning apparatus 100 may use a few dozen to hundreds of machine learning algorithms, for example. Examples of the machine learning algorithms include a logistic regression analysis, a support vector machine, and a random forest.

The logistic regression analysis is a regression analysis in which a value of an objective variable y and values of explanatory variables x₁, x₂, . . . , xₖ are fitted with an S-shaped curve. The objective variable y and the explanatory variables x₁ to xₖ are assumed to satisfy the relationship log (y/(1−y))=a₁x₁+a₂x₂+ . . . +aₖxₖ+b wherein a₁, a₂, . . . , aₖ, and b are coefficients determined by a regression analysis.

The support vector machine is a machine learning algorithm that calculates a boundary that divides a set of unit data in a space into two classes in the clearest way. The boundary is calculated in such a manner that the maximum distance (margin) is obtained between the classes.

The random forest is a machine learning algorithm that generates a model for appropriately classifying a plurality of unit data. In the random forest, the machine learning apparatus 100 randomly samples unit data from a data population. The machine learning apparatus 100 randomly selects a part of the explanatory variables and classifies the sampled unit data according to a value of the selected explanatory variable. By repeating the selection of an explanatory variable and the classification of the unit data, the machine learning apparatus 100 generates a hierarchical decision tree based on the values of a plurality of explanatory variables. By repeating the sampling of the unit data and the generation of the decision tree, the machine learning apparatus 100 acquires a plurality of decision trees. By synthesizing these decision trees, the machine learning apparatus 100 generates a final model for classifying the unit data.

There is a machine learning algorithm having at least one hyperparameter for controlling its behavior. Unlike a coefficient (parameter) included in a model, a value of the hyperparameter is not determined through machine learning but is given before the machine learning algorithm is performed. Examples of the hyperparameter include the number of decision trees generated in a random forest, the fitting accuracy in a regression analysis, and the number of degrees of a polynomial included in a model. As the value of the hyperparameter, a fixed value or a value specified by a user may be used. The prediction performance of a generated model also depends on the value of the hyperparameter. Even when the same machine learning algorithm and the same sample size are used, if the value of the hyperparameter changes, the prediction performance of the model could change.

In the second embodiment, when machine learning algorithms of the same kind are used and when the values of hyperparameters are different, the machine learning apparatus 100 may assume that different machine learning algorithms have been used. A combination of the kind of a machine learning algorithm and the value of a hyperparameter will be referred to as a “configuration”, as needed. Namely, the machine learning apparatus 100 may handle different configurations as different machine learning algorithms.

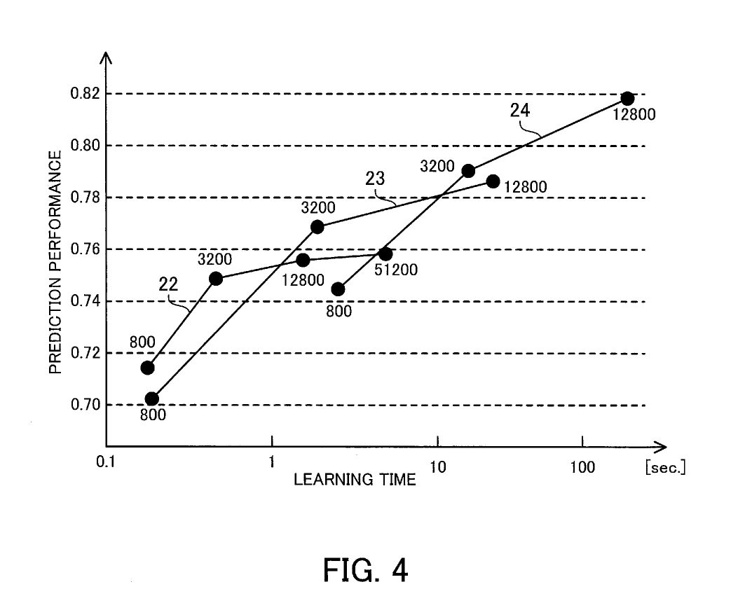

FIG. 4 is a graph illustrating an example of a relationship between learning time and prediction performances.

Curves 22 to 24 illustrate a relationship between learning time and prediction performances measured by using a noted data set (CoverType). As the index representing the prediction performance, the accuracy is used in this example. The curve 22 illustrates a relationship between the learning time and the prediction performance when a logistic regression analysis is used as the machine learning algorithm. The curve 23 illustrates a relationship between the learning time and the prediction performance when a support vector machine is used as the machine learning algorithm. The curve 24 illustrates a relationship between the learning time and the prediction performance when a random forest is used as the machine learning algorithm. The horizontal axis in FIG. 4 represents the learning time on the logarithmic scale.

As illustrated by the curve 22 obtained by using the logistic regression analysis, when the sample size is 800, the prediction performance is about 0.71, and the learning time is about 0.2 seconds. When the sample size is 3,200, the prediction performance is about 0.75, and the learning time is about 0.5 seconds. When the sample size is 12,800, the prediction performance is about 0.755, and the learning time is 1.5 seconds. When the sample size is 51,200, the prediction performance is about 0.76, and the learning time is about 6 seconds.

As illustrated by the curve 23 obtained by using the support vector machine, when the sample size is 800, the prediction performance is about 0.70, and the learning time is about 0.2 seconds. When the sample size is 3,200, the prediction performance is about 0.77, and the learning time is about 2 seconds. When the sample size is 12,800, the prediction performance is about 0.785, and the learning time is about 20 seconds.

As illustrated by the curve 24 obtained by using the random forest, when the sample size is 800, the prediction performance is about 0.74, and the learning time is about 2.5 seconds. When the sample size is 3,200, the prediction performance is about 0.79, and the learning time is about 15 seconds. When the sample size is 12,800, the prediction performance is about 0.82, and the learning time is about 200 seconds.

As described above, when the logistic regression analysis is used on the above data set, overall, the learning time is short and the prediction performance is low. When the support vector machine is used, overall, the learning time is longer and the prediction performance is higher than those obtained when the logistic regression analysis is used. When the random forest is used, overall, the learning time is longer and the prediction performance is higher than those obtained when the support vector machine is used. However, in the example in FIG. 4, when the sample size is small, the prediction performance obtained by using the support vector machine is lower than that obtained by using the logistic regression analysis. Namely, even when progressive sampling is used, the increase curve of the prediction performance at the initial stage varies depending on the machine learning algorithm.

In addition, as described above, the maximum level or the increase curve of the prediction performance of an individual machine learning algorithm also depends on the nature of the data used. Thus, among a plurality of machine learning algorithms, it is difficult to previously determine a machine learning algorithm that achieves the highest or nearly the highest prediction performance within the shortest time. However, the machine learning apparatus 100 efficiently obtains a model having a high prediction performance by using a plurality of machine learning algorithms as will be described below.

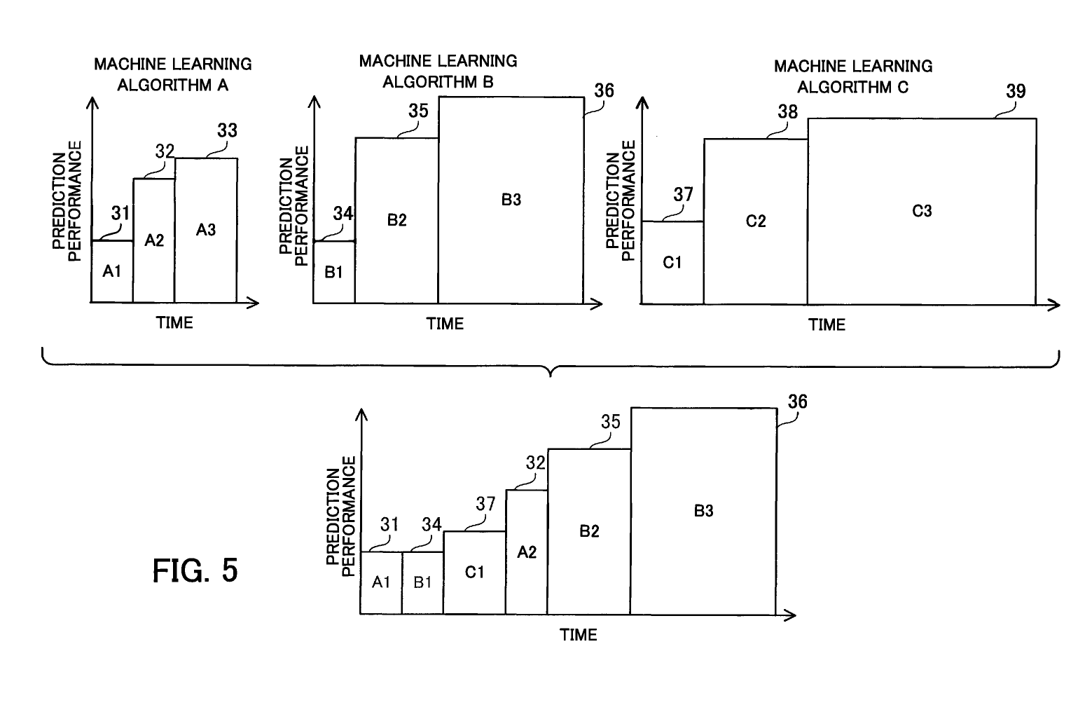

FIG. 5 illustrates an example of use of a plurality of machine learning algorithms.

For ease of description, the following description assumes that the machine learning apparatus 100 uses three machine learning algorithms A to C. When performing progressive sampling by using only the machine learning algorithm A, the machine learning apparatus 100 executes learning steps 31 to 33 (A1 to A3) in this order. When performing progressive sampling by using only the machine learning algorithm B, the machine learning apparatus 100 executes learning steps 34 to 36 (B1 to B3) in this order. When performing progressive sampling by using only the machine learning algorithm C, the machine learning apparatus 100 executes learning steps 37 to 39 (C1 to C3) in this order. This example assumes that a stopping condition is satisfied each at the learning steps 33, 36, and 39.

The same sample size is used in the learning steps 31, 34, and 37. For example, the number of unit data is 10,000 in the learning steps 31, 34, and 37. The same sample size is used in the learning steps 32, 35, and 38, which is about twice or four times of the sample size used in the learning steps 31, 34, and 37. For example, the number of unit data in the learning steps 32, 35, and 38 is 40,000. The same sample size is used in the learning steps 33, 36, and 39, which is about twice or four times of the sample size used in the learning steps 32, 35, and 38. For example, the number of unit data used in the learning steps 33, 36, and 39 is 160,000.

Per machine learning algorithm, the machine learning apparatus 100 estimates the improvement rate of the prediction performance of a model learned when a learning step using the next sample size is performed. Next, the machine learning apparatus 100 selects and executes a machine learning algorithm that indicates the highest improvement rate. Every time the machine learning apparatus 100 advances the learning step, the individual estimated value of the improvement rate is reviewed. Thus, while the learning steps of a plurality of machine learning algorithms are performed at first, the number of the machine learning algorithms performed is gradually decreased.

The estimated improvement rate value is obtained by dividing the estimated performance improvement amount value by the estimated execution time value. The estimated performance improvement amount value is the difference between the estimated prediction performance value in the next learning step and the maximal prediction performance value achieved up until now through the plurality of machine learning algorithms (which may hereinafter be referred to as an achieved prediction performance). The prediction performance in the next learning step is estimated based on at least one past prediction performance of the same machine learning algorithm and the sample size used in the next learning step. The estimated execution time value is an estimated value representing the time needed for the next learning step and is estimated based on at least one past execution time of the same machine learning algorithm and the sample size used in the next learning step.

The machine learning apparatus 100 executes the learning steps 31, 34, and 37 of the machine learning algorithms A to C, respectively. The machine learning apparatus 100 estimates the improvement rates of the machine learning algorithms A to C based on the execution results of the learning steps 31, 34, and 37. Assuming that the machine learning apparatus 100 has estimated that the improvement rates of the machine learning algorithms A to C are 2.5, 2.0, and 1.0, respectively, the machine learning apparatus 100 selects the machine learning algorithm A that indicates the highest improvement rate and executes the learning step 32.

After executing the learning step 32, the machine learning apparatus 100 updates the improvement rates of the machine learning algorithms A to C. The following description assumes that the machine learning apparatus 100 has estimated the improvement rates of the machine learning algorithms A to C to be 0.73, 1.0, and 0.5, respectively. Since the achieved prediction performance has been increased by the learning step 32, the improvement rates of the machine learning algorithms B and C have also been decreased. The machine learning apparatus 100 selects the machine learning algorithm B that indicates the highest improvement rate and executes the learning step 35.

After executing the learning step 35, the machine learning apparatus 100 updates the improvement rates of the machine learning algorithms A to C. Assuming that the machine learning apparatus 100 has estimated the improvement rates of the machine learning algorithms A to C to be 0.0, 0.8, and 0.0, respectively, the machine learning apparatus 100 selects the machine learning algorithm B that indicates the highest improvement rate and executes the learning step 36. When the machine learning apparatus 100 determines that the prediction performance has sufficiently increased by the learning step 36, the machine learning apparatus 100 ends the machine learning. In this case, the machine learning apparatus 100 does not execute the learning step 33 of the machine learning algorithm A and the learning steps 38 and 39 of the machine learning algorithm C.

Since the machine learning apparatus 100 does not execute the learning steps that do not contribute to improvement in prediction performance, the overall learning time is shortened. In addition, the machine learning apparatus 100 preferentially executes a learning step of a machine learning algorithm that indicates the maximum performance improvement amount per unit time. Thus, even when the learning time is limited and the machine learning is stopped before its completion, a model obtained when the machine learning is stopped is the best model obtainable within the time limit. In addition, while the learning steps that contribute to improvement in prediction performance (even if the improvement is very little) could be executed later in the execution order, these learning steps could be executed. Thus, the risk of eliminating a machine learning algorithm that could generate a model whose maximum prediction performance is high is reduced.

Next, the estimation of a prediction performance will be described.

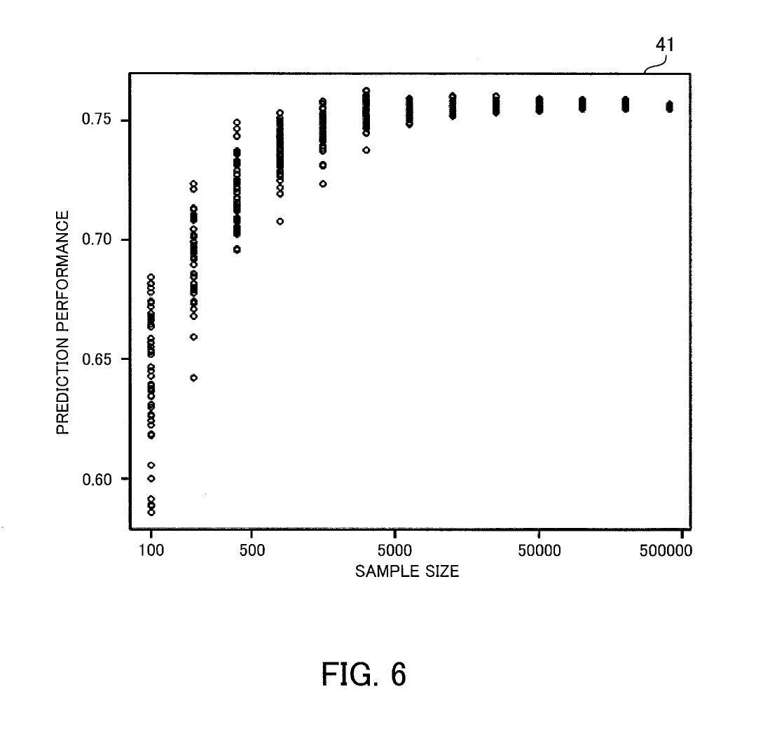

FIG. 6 is a graph illustrating an example of a distribution of prediction performances.

A measured prediction performance value corresponding to a sample size could differ from an expected value determined from the machine learning algorithm and the nature of the data population. Namely, even when the same data population is used, depending on, for example, the contingency in the selection of the training data and the test data, the measured prediction performance value varies. The variation of the prediction performance tends to be larger when the sample size is smaller and tends to be smaller when the sample size is larger. Namely, there is heteroscedasticity in which the degree (standard deviation or variance) of the variation of the prediction performance varies depending on the sample size.

A graph 41 illustrates a relationship between sample sizes and prediction performances. In this example, 50 learning steps are performed per sample size by using the same machine learning algorithm and the same data population. In the graph 41, 50 measured prediction performance values are plotted per sample size. In the graph 41, accuracy is used as the index of the prediction performance, and a higher index value indicates a higher prediction performance.

In this example, as illustrated in the graph 41, when the sample size is “100”, the measured prediction performance values fall in a wide range from about 0.58 to 0.68. When the sample size “500”, the measured prediction performance values fall in a range from about 0.69 to 0.75, and this range is narrower than that obtained when the sample size is “100”. Subsequently, the range of the measured prediction performance values narrows as the sample size increases. When the sample size becomes sufficiently large, the measured prediction performance values converge into a range around 0.76.

As described above, per machine learning algorithm, the machine learning apparatus 100 estimates a prediction performance achieved when the next learning step is performed. To estimate a prediction performance, the machine learning apparatus 100 estimates a prediction performance curve based on at least one measured prediction performance value that has been acquired so far. However, a measured prediction performance value (in particular, a measured prediction performance value corresponding to a small sample size) could differ from the corresponding expected value. Thus, the estimation accuracy of the prediction performance curve could be a problem. To avoid this problem, the machine learning apparatus 100 estimates the prediction performance curve as follows.

First, an idea of bias-variance decomposition will be described. There are cases in which bias-variance decomposition is used to evaluate a single machine learning algorithm or a hyperparameter applied to a machine learning algorithm. In bias-variance decomposition, three indexes called loss, bias, and variance are used. A relationship, which is loss=square of bias+variance, is established.

The “loss” is an index which indicates the probability with which a model generated by machine learning results in a false prediction. Examples of the loss include a 0-1 loss and a squared loss. The “0-1 loss” is calculated by adding 0 if the prediction is successful and adding 1 if the prediction is unsuccessful, and an expected value of the 0-1 loss indicates a probability with which the prediction is unsuccessful. If the probability of a successful prediction is higher, the expected value of the 0-1 loss is smaller. If the probability of a successful prediction is lower, the expected value of the 0-1 loss is larger. The “squared loss” is a square of the difference (predicted error) between a predicted value and a true value. A smaller predicted error results in a smaller squared loss, and a larger predicted error results in a larger squared loss. An expected loss (expected value of loss) and a prediction performance are mutually convertible. When the prediction performance is accuracy and the loss is the 0-1 loss, the expected loss is represented by “1—prediction performance”. When the prediction performance is an MSE and the loss is a squared loss, the expected loss is represented by an MSE. When the prediction performance is an RMSE and the loss is a squared loss, the expected loss is represented by a square of the RMSE.

The “bias” is an index which indicates the degree to which a predicted value of a model generated by machine learning is biased to a true value. A smaller bias indicates a more accurate model. The “variance” is an index which indicates the degree to which a predicted value of a model generated by machine learning varies. A smaller variance indicates a more accurate model. However, in many cases, the bias and the variance have a trade-off relationship.

In the case of a model having low complexity, such as a polynomial of a small degree (a model having a narrow expression range), no matter how an individual coefficient of the model is adjusted, it is difficult for the model to output a predicted value close to a corresponding true value for each of a plurality of sample cases. Namely, when a model having low complexity is used, a complex matter is not expressed. Thus, such a model having low complexity tends to have a large bias. In this respect, in the case of a model having high complexity such as a polynomial of a large degree (a model having a wide expression range), by appropriately adjusting an individual coefficient of the model, the model is able to output a predicted value close to the corresponding true value for each of a plurality of sample cases. Thus, the model having high complexity tends to have a low bias.

However, in the case of such a model having high complexity, there is a risk of overtraining. Namely, a model that is excessively dependent on a feature of a sample case used as training data could be generated. In many cases, a model generated by overtraining is unable to output appropriate predicated values for other sample cases. For example, when a polynomial of degree n is used, it is possible to generate a model (a model whose residual error is 0) which outputs a predicted value that completely matches the corresponding true value for n+1 sample cases. However, a model whose residual error is 0 for certain sample cases is normally an excessively complex model, and the risk of outputting predicted values whose predicted errors are significantly large for other sample cases is high. Thus, a model having high complexity tends to have a large variance. In this respect, in the case of a model having low complexity, the risk of outputting predicted values whose predicted errors are significantly large is low, and the model tends to have a small variance. As described above, the bias and the variance as the components of a loss depend on characteristics of a machine learning algorithm which generates a model.

Next, the definitions of the formality of the loss, bias, and variance will be described. The following description will be made based on an example in which a squared loss is decomposed into a bias and a variance.

In addition, the following description assumes that K training data Dₖ (k=1, 2, . . . , K) has been extracted from the same data population and that K models have been generated. In addition, the following description assumes that test data T including n test cases has been extracted from the above data population. An i-th test case includes a value Xᵢ of an explanatory variable and a true value Yᵢ of an objective variable (i=1, 2, . . . , n). From a k-th model, a predicated value yᵢₖ of an objective variable for the value Xᵢ of the explanatory variable is calculated.

A predicated error eᵢₖ calculated between the k-th model and the i-th test case is defined as eᵢₖ=Yᵢ−yᵢₖ, and the loss (squared loss) is defined as eᵢₖ². For the i-th test case, a bias Bᵢ, a variance Vᵢ, and a loss Lᵢ are defined. The bias Bᵢ is defined as Bᵢ=E_{D}[eᵢₖ], and E_{D}[ ] represents an average value (expected value) among the K training data. The variance Vᵢ is defined as Vᵢ=Vₚ[eᵢₖ], and V_{D}[ ] represents a variance among the K training data. The loss Lᵢ is defined as Lᵢ=E_{D}[eᵢₖ²]. From the above relationship among the loss, bias, and variance, Lᵢ=Bᵢ²+Vᵢ is established.

For the whole test data T, an expected bias EB2, an expected variance EV, and an expected loss EL are defined. The expected bias EB2 is defined as EB2=Eₓ[Bᵢ²], and Eₓ[ ] represents an average value (expected value) among the n test cases. The expected variance EV is defined as EV=Eₓ[Vᵢ], and the expected loss EL is defined as EL=Eₓ[Lᵢ]. From the above relationship among the loss, the bias, and the variance, EL=EB2+EV is established.

Next, a method for estimating the variation (variance) of a prediction performance measured with respect to a sample size when a prediction performance curve is estimated will be described. According to the second embodiment, the above idea of bias-variance decomposition is applied to estimate the variance of a prediction performance.

The inventors of the present application have found that the variance of a prediction performance corresponding to a sample size is approximated by VLⱼ=C×(ELⱼ+EB2)×(ELⱼ−EB2) in which VLⱼ represents the variance of the prediction performance corresponding to a sample size sⱼ and C represents a predetermined constant. According to the second embodiment, since the ratio among the variances VLⱼ of a plurality of sample sizes is used to estimate a prediction performance curve, the value of the constant C may be unknown. For example, C may be assumed to be 1. ELⱼ represents the expected loss corresponding to the sample size sⱼ. EB2 represents the expected bias of the corresponding machine learning algorithm. Hereinafter, this mathematical formula will be described in more detail.

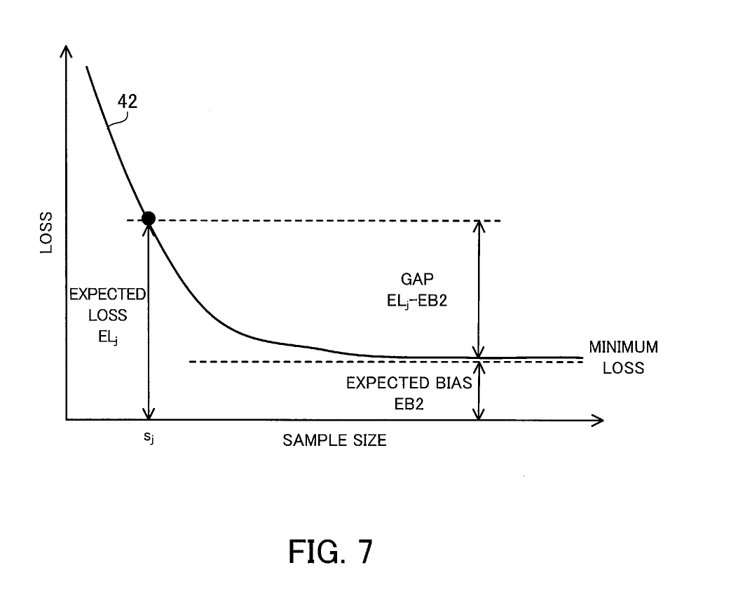

FIG. 7 is a graph illustrating an example of a relationship between sample sizes and losses.

A curve 42 is a loss curve which indicates a relationship between sample sizes and estimated loss values. While the vertical axis in FIG. 3 represents the prediction performance per sample size, the vertical axis in FIG. 7 represents the loss per sample size. As described above, the prediction performance and the loss are mutually convertible based on their respective indexes. The curve 42 is a non-linear curve in which the loss monotonically decreases as the sample size increases and asymptotically comes close to a certain minimum loss. While the decrease amount of the loss is large when the sample size is small, the decrease amount of the loss becomes less as the sample size increases.

The loss on a point on the curve 42, the point corresponding to the sample size sⱼ (the distance from loss=0 to the point on the curve 42), corresponds to the expected loss ELⱼ when the sample size sⱼ is used. The minimum loss determined by the curve 42 corresponds to the maximum prediction performance determined by the curve 21 in FIG. 3 and is a value larger than 0. For example, when the maximum prediction performance is c and when the prediction performance is expressed as accuracy, the minimum loss is represented by 1−c. When the prediction performance is an MSE, the minimum loss is c. When the prediction performance is an RMSE, the minimum loss is c². The minimum loss corresponds to the expected bias EB2 of this machine learning algorithm. This is because, when the sample size becomes sufficiently large, characteristics of the training data used for the machine learning match those of the data population, and the expected variance comes close to 0.

It is fair to say that the difference between the expected loss ELⱼ and expected bias EB2 is a gap when the sample size sⱼ is used. The gap represents room for the machine learning algorithm to reduce the loss by increasing the sample size. It is also fair to say that the gap corresponds to the distance between a point on the curve 21 in FIG. 3 and the maximum prediction performance and represents room for the machine learning algorithm to improve the prediction performance by increasing the sample size. The gap is affected by the expected variance corresponding to the sample size sⱼ.

The approximate expression of the variance VLⱼ includes a term EL+EB2 and a term ELⱼ−EB2. This means that the variance VLⱼ is proportional to the sum of the expected loss and the expected bias and is proportional to the gap, which is the difference between the expected loss and the expected bias.

In the case of a machine learning algorithm whose expected bias EB2 is sufficiently small, namely, whose maximum prediction performance is sufficiently large, even when the sample size becomes relatively large, both the value of ELⱼ+EB2 and the value of ELⱼ−EB2 change.

In addition, in this case, the value of ELⱼ+EB2 is approximated to the value of ELⱼ−EB2. Thus, as a whole, the variance VLⱼ tends to be proportional to the square of the gap. In contrast, in the case of a machine learning algorithm whose expected bias EB2 is sufficiently large, namely, whose maximum prediction performance is not sufficiently large, when the sample size becomes relatively large, the value of ELⱼ+EB2 changes little and is seen as a constant at an early stage. Thus, as a whole, the variance VLⱼ tends to be proportional to the gap. Thus, depending on the machine learning algorithm, there are cases in which the variance VLⱼ is approximately proportional to the square of the gap and in which the variance VLⱼ is proportional to the gap.

As will be described, according to the second embodiment, by using the characteristics of the formula VLⱼ=C×(ELⱼ+EB2)×(ELⱼ−EB2), a prediction performance curve based on heteroscedasticity is estimated.

Next, the variation of an estimated prediction performance value on a prediction performance curve will be described.

As described above, the machine learning apparatus 100 uses an estimated improvement rate value obtained by dividing an estimated performance improvement amount value by an estimated execution time value. It is preferable that, as the estimated performance improvement amount value herein, a value larger than an expected value on a prediction performance curve be used in view of the variation of the prediction performance, instead of the expected value. In this way, the risk of eliminating a machine learning algorithm whose prediction performance could become much better than the expected value is reduced.

Examples of the information (variance information) which indicates the degree of the variation of the prediction performance include a confidence interval, a prediction interval, a variance, a standard deviation, and a probability distribution. The confidence interval is a confidence interval of a point (expected value) on a regression curve calculated by a regression analysis. A 95% confidence interval indicates, when estimated values based on a regression curve have a probability distribution around expected values, the range in which the cumulative probability is from 2.5% to 97.5%, the cumulative probability having been calculated in ascending order of estimated value. The prediction interval is an interval obtained by adding an error distribution to the confidence interval. A distribution of estimated values based on a regression curve is further widened based on errors, and the prediction interval is obtained in view of the width of the distribution. The 95% prediction interval indicates the range in which the cumulative probability is from 2.5% to 97.5% in the probability distribution to which the error distribution has been added.

In many cases, the variance information such as the confidence interval, the prediction interval, the variance, the standard deviation, and the probability distribution is mutually convertible. In many cases, if a single variance information is obtained, it is possible to calculate other variance information. According to the second embodiment, as the variance information, a 95% confidence interval is calculated. The machine learning apparatus 100 uses an upper confidence bound (UCB) of a 95% confidence interval as an estimated prediction performance value used to calculate an improvement rate. This is a result of quantitative evaluation of the possibility that a prediction performance exceeds a corresponding expected value. Alternatively, instead of the UCB, the probability distribution of prediction performances may be integrated, and the probability (PI: probability of improvement) that a prediction performance exceeds the achieved prediction performance may be calculated. Alternatively, the probability distribution of prediction performances may be integrated, and an expected value (EI: expected improvement) indicating that a prediction performance exceeds the achieved prediction performance may be calculated.

Since an individual prediction performance curve has heteroscedasticity, there is a problem of how a confidence interval corresponding to a sample size needs to be calculated. Hereinafter, first, two calculation methods will be described as examples, and next, a third calculation method adopted by the machine learning apparatus 100 will be described. First, symbols used in the description of the confidence interval calculation methods will be defined.

The prediction performance curve (in other words, a learning curve) is defined as y=f(x; θ), wherein y represents an estimated prediction performance value, f represents a function which indicates the prediction performance curve, x represents a sample size, and θ represents a parameter vector, which is a group of parameters that determines the shape of the prediction performance curve. According to the second embodiment, as an example, f(x; θ)=c−a·x^{-d} is used. Since the shape of this prediction performance curve is determined by parameters a, c, and d, θ=<a, c, d>, wherein d>0. In addition, a prediction performance curve including an error is defined as Y=f(x; θ)+ε_{|x, θ}, wherein Y represents a random variable which indicates an estimated prediction performance value including an error. In the formula, ε_{|x, θ} has heteroscedasticity in which the variance depends on x or θ and is a random variable which indicates an error whose expected value is 0. This means that the variance of the error is not a constant, and heteroscedasticity is established (homoscedasticity is not established).

Data X={<x, y>} is used to estimate a prediction performance curve, wherein x is a sample size, and y is a measured prediction performance value. In addition, the following description assumes the following likelihood function, posterior probability (posterior probability function), and error probability density function have been defined. The likelihood function is L(θ; X)=P(X|θ), the posterior probability is Pₚₒₛₜₑᵣᵢₒᵣ(θ|X), and the error probability density function of ε_{|x, θ} is fₑᵣᵣ(ε; x, θ). The likelihood function represents a probability that the data X is observed based on the prediction performance curve in accordance with the determined parameter vector θ. The posterior probability represents the probability that the determined parameter vector θ is accurate under the data X. Only one of the likelihood function and the posterior probability may be given.

Definition examples of the likelihood function L(θ; X), the posterior probability Pₚₒₛₜₑᵣᵢₒᵣ (θ|X), and the error probability density function fₑᵣᵣ(ε, x, θ) will be described. The following description assumes that an error ε_{|x, θ} has an expected value of 0 and is in accordance with a normal distribution indicated by variance v(x, θ)=(f(x; θ)−c)²/16. In this case, the error probability density function is defined as fₑᵣᵣ(ε; x, θ)=1/(2πv(x, θ))^{0.5}·exp(−ε²/(2v(x, θ))). The likelihood function with respect to the parameter vector θ is defined as L(θ; X)=P(X|θ)=Πᵢfₑᵣᵣ(f (xᵢ; θ)−yᵢ; xᵢ, θ), wherein xᵢ and yᵢ are components of the i-th elements <xᵢ, yᵢ> included in the data X.

The posterior probability is defined as Pₚₒₛₜₑᵣᵢₒᵣ(θ|X)=P(X|θ)·Pₚᵣᵢₒᵣ(θ)/Σ_{θ′}(P(X|θ′)·P(θ′)). Since Σ_{θ′}(P(X|θ′)·P(θ′)) is a constant for normalization, Σ_{θ′}(P(X|θ′)·P(θ′)) is replaced by C₁. Assuming that the prior distributions of a and c are uniform distributions and the prior distribution of d is a gamma distribution Gamma (2, ⅓), the prior probability Pₚᵣᵢₒᵣ(θ) is defined as Pₚᵣᵢₒᵣ(θ)=C₂·9d/exp(3d) by using a normalization constant C₂. Thus, the posterior probability is defined as Pₚₒₛₜₑᵣᵢₒᵣ(θ|X)=C₃·L(θ; X)·9d/exp(3d) by using normalization constants C₃=C₂/C₁.

Three confidence interval calculation methods will be described by using the above symbols.

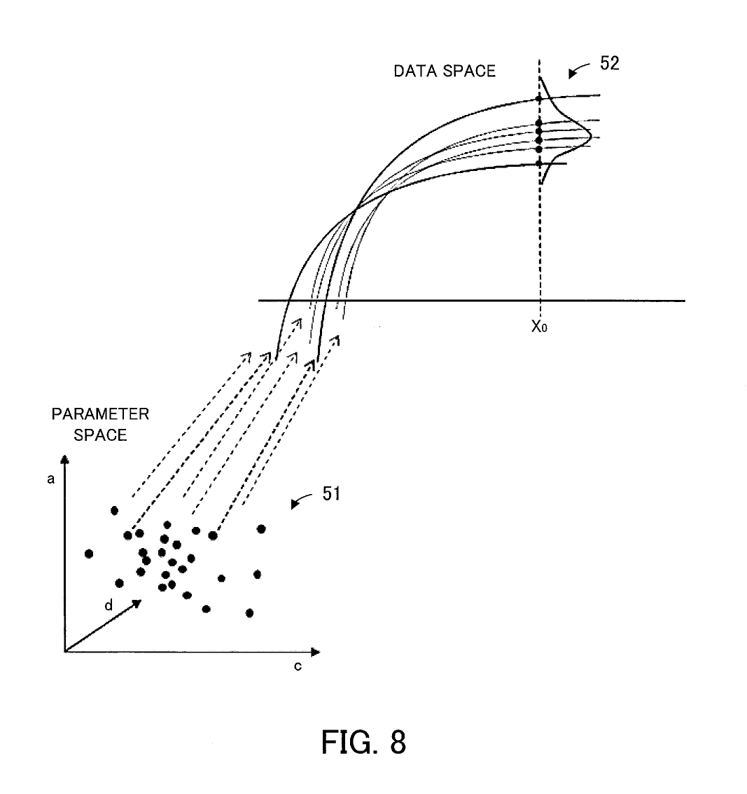

FIG. 8 illustrates an example of a first confidence interval calculation method.

The first confidence interval calculation method is a simple random sampling method. In the first calculation method, a plurality of parameter vectors are sampled from a parameter space 51 by using the MCMC methods or the like. Next, in a data space 52, by using a plurality of prediction performance curves in accordance with the sampled parameter vectors, a probability distribution of estimated prediction performance values corresponding to a sample size x₀ is approximated.

First, by using the likelihood function L(θ; X) or the posterior probability Pₚₒₛₜₑᵣᵢₒᵣ(θ|X) with respect to a parameter vector θ determined by a regression analysis as the probability density function, 50,000 parameter vectors are sampled from the parameter space 51. The parameter vectors are sampled by using the MCMC methods such as a Metropolis-Hasting algorithm method. More parameter vectors close to the parameter vector θ determined by the regression analysis are sampled, and fewer parameter vectors far from the determined parameter vector θ are sampled.

Next, in the data space 52, 50,000 prediction performance curves f(x; 0ᵢ) corresponding to the sampled 50,000 parameter vectors θᵢ (i=1, 2, . . . , 50,000) are assumed, and 50,000 prediction performances yᵢ (yᵢ=f(x₀; θᵢ)) corresponding to the desired sample size x₀ are calculated. With the 50,000 prediction performances, a probability distribution of estimated values corresponding to the sample size x₀ is approximated. A 95% confidence interval corresponding to the sample size x₀ is calculated as (a, b), assuming that the prediction performances at 2.5% (2.5% quantile) and 97.5% (97.5% quantile) from the lowest prediction performance among the 50,000 prediction performances are a and b.

According to the first calculation method, to calculate the confidence interval accurately, many parameter vectors need to be sampled. Thus, there are problems in that the computational load is high and the calculation time is long.

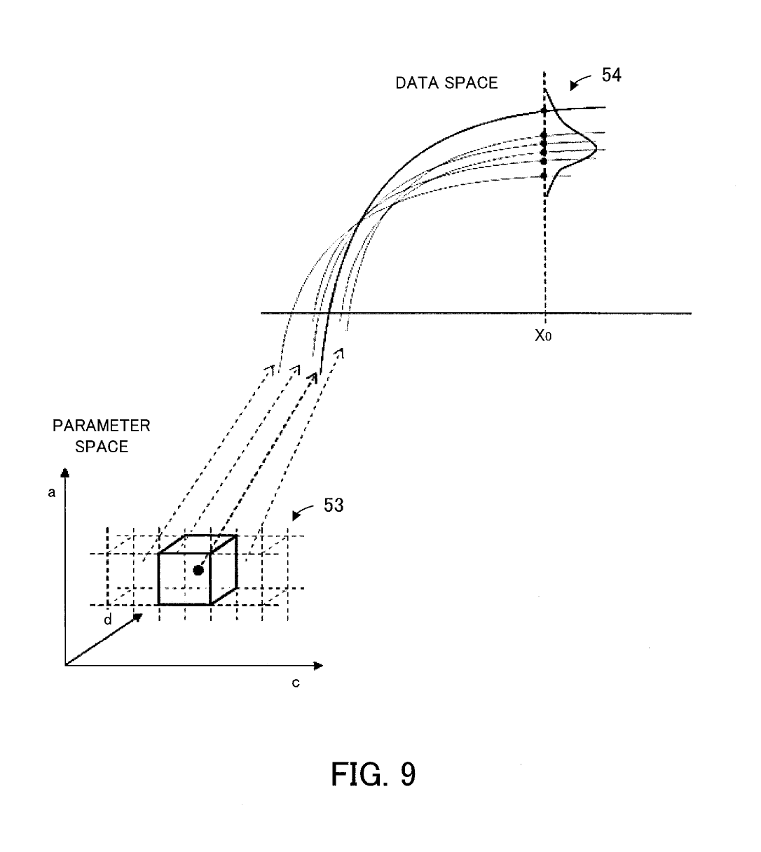

FIG. 9 is an example of a second confidence interval calculation method.

The second confidence interval calculation method is a weighted sampling method. According to the second calculation method, a parameter space 53 is divided into grids each having a predetermined width, and parameter vectors are sampled from the respective grids. Each of the sampled parameter vectors is a representative value (for example, a center value of each grid). In addition, a weight is determined per sampled parameter vector. Next, in a data space 54, by using a plurality of prediction performance curves in accordance with the sampled parameter vectors and the weights, a probability distribution of estimated prediction performance values corresponding to the sample size x₀ is approximated.

First, the parameter space 53 is divided into about 1,000 grids, and parameter vectors θᵢ(i=1, 2, . . . , 1,000) are selected from the respective grids, the parameter vectors θᵢ being the representative values from the respective grids. Next, the probability of each grid is calculated as pᵢ=L(θᵢ|X) or pᵢ=Pₚₒₛₜₑᵣᵢₒᵣ(θᵢ|X) by using the likelihood function or the posterior probability, to set the weights of the respective parameter vectors θᵢ.

Next, in the data space 54, 1,000 prediction performance curves f(x; θᵢ) corresponding to the 1,000 sampled parameter vectors θᵢ are assumed, and 1,000 prediction performances yᵢ (yᵢ=f(x₀; θᵢ)) corresponding to the desired sample size x₀ are calculated. By using 1,000 prediction performances and the weights, a probability distribution of estimated values corresponding to the sample size x₀ is approximated. A 95% confidence interval corresponding to the sample size x₀ is calculated as (a, b), assuming that the prediction performances whose cumulated weight is 2.5% (weighted 2.5% quantile) and whose cumulated weight is 97.5% (weighted 97.5% quantile) among the 1,000 weighted prediction performances are a and b.

According to the second calculation method, fewer parameter vectors are sampled than those according to the first calculation method. However, the second calculation method has a problem in that how the parameter space 53 is divided into grids. If a large grid width is set, the accuracy of calculating the confidence interval decreases. In contrast, if a small grid width is set, since the computational load increases, a longer calculation time is needed. In addition, if the grids are formed only around the parameter vector θ determined by the regression analysis, the accuracy of calculating the confidence interval decreases. In contrast, if the grids are formed in an area far from the parameter vector θ, since the computational load increases, a longer calculation time is needed. While the method in which the parameter space 53 is divided into grids has been described, other methods such as a method in which the parameter vectors are uniformly sampled from the parameter space 53 could have the same problem.

In contrast, the machine learning apparatus 100 according to the second embodiment calculates a confidence interval of an estimated value corresponding to a desired sample size by using the following third calculation method.

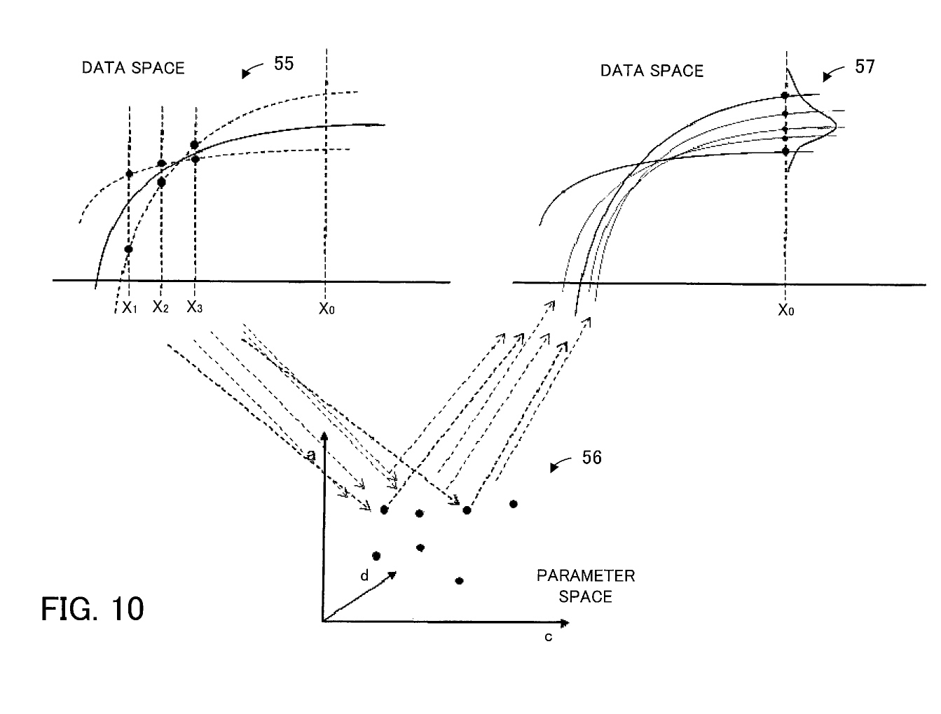

FIG. 10 illustrates an example of the third confidence interval calculation method.

According to the above second calculation method, the criteria for selecting appropriate parameter vectors in the parameter space 53 is not clear. In contrast, the third calculation method uses the nature that many prediction performance curves obtained in view of errors are distributed around the most probable prediction performance curve, namely, a single prediction performance curve determined by a regression analysis. A plurality of prediction performance curves in view of errors are sampled in a data space 55, and the probabilities of the respective parameter vectors are obtained by mapping the sampled prediction performance curves on a plurality of parameter vectors in a parameter space 56. The probabilities in the parameter space 56 are converted into probabilities in the data space 57, and a weight is obtained per prediction performance curve. Consequently, a probability distribution of estimated prediction performance values corresponding to the sample size x₀ is approximated.

The following description assumes that the number of parameters included in a parameter vector (the number of degrees of the parameter vector θ) is M. When θ=<a, c, d>, M=3. First, the machine learning apparatus 100 generates a prediction performance curve f(x; θ₀) from the data X by a regression analysis, wherein θ₀ represents the most probable parameter vector determined by the regression analysis. Next, the machine learning apparatus 100 selects M different sample sizes x₁, x₂, . . . , x_{M} (x₁<x₂< . . . <x_{M}) from the sample sizes (executed sample sizes) included in the data X. When M=3, the machine learning apparatus 100 selects the sample size x₁ to x₃ (x₁<x₂<x₃). It is preferable that the M sample sizes be selected uniformly. For example, x₁ and x₃ are the 25% and 75% quantiles in the data X, respectively, and x₂ is the geometric mean of x₁ and x₃ (x₂=(x₁·x₃)^{0.5})

Next, for each sample size xᵢ, the machine learning apparatus 100 obtains the range [aᵢ, bᵢ] of the prediction performances yᵢ whose probability is equal to or more than a predetermined threshold (for example, 10⁻⁶) by using the error probability density function fₑᵣᵣ(ε, x, θ). For example, when the error probability density function fₑᵣᵣ (ε; x₁, θ) is a probability density function of a standard normal distribution, the range of a prediction performance y₁ is f(x₁; θ₀)−4.75≤y₁≤f(x₁; θ₀)+4.75. The machine learning apparatus 100 samples a single prediction performance in the range [aᵢ, bᵢ] per sample size xᵢ and generates a sample point sequence Yⱼ=<y₁, y₂, . . . y_{M}>. When M=3, the machine learning apparatus 100 generates a sample point sequence Yⱼ=y₁, y₂, y₃>. Sampling of the sample point sequence Yⱼ is uniform sampling from [a₁, b₁]×[a₂, b₂]× . . . ×[aₘ, bₘ]. It is possible to perform this uniform sampling efficiently by using quasi-random numbers (low-discrepancy sequences). Instead of sampling in accordance with a uniform distribution, systematic sampling may be performed.

The machine learning apparatus 100 generates N sample point sequences Y₁, Y₂, . . . , Y_{N} by repeating the above sampling N times. For example, N=9^{M}. When M=3, since N=729, the machine learning apparatus 100 generates 729 sample point sequences Y₁, Y₂, . . . , Y₇₂₉. In this way, sampling is performed around the parameter vector θ₀ in the data space 55. The number of sample sizes to be selected may be larger than the number M of degrees of the parameter vector θ. By setting the number of sample sizes to be selected to M or more, a single prediction performance curve is derived from a single sample point sequence. When the number of sample sizes to be selected is M, a single prediction performance curve that passes all M points included in a single sample point sequence is determined. In this case, it is possible to calculate M parameters analytically in accordance with a mathematical formula. In contrast, when the number of sample sizes to be selected is larger than M, the best prediction performance curve is calculated by a regression analysis.

Next, the machine learning apparatus 100 calculates N parameter vectors θⱼ corresponding to the N sample point sequences Yⱼ. When the number of sample sizes to be selected is M, a single parameter vector represents a prediction performance curve that passes all the points of a single sample point sequence. The parameter vectors θⱼ may be solved analytically or calculated by a regression analysis. In this way, the N parameter vectors θⱼ are sampled in the parameter space 56. These parameter vectors θⱼ are those that have been appropriately sampled around the parameter vector θ₀.

Next, the machine learning apparatus 100 calculates occurrence probabilities qⱼ on the data X for the respective N parameter vectors θⱼ. The individual occurrence probability is calculated as qⱼ=L(θⱼ; X) by using the likelihood function or calculated as qⱼ=Pₚₒₛₜₑᵣᵢₒᵣ(θⱼ|X) by using the posterior probability.

Appropriate parameter vectors could not be calculated from some sample point sequences such as a sample point sequence which indicates a curve having a downward convex. In such a case, the occurrence probability may be set as qⱼ=0.

Next, the machine learning apparatus 100 converts the occurrence probabilities qⱼ of the N parameter vectors θⱼ in the parameter space 56 into the occurrence probabilities pⱼ of the N sample point sequences Yⱼ in the data space 57. The occurrence probability pⱼ of a sample point sequences Yⱼ is calculated as expressed by mathematical formula (1) by using the occurrence probability qⱼ of a parameter vector θⱼ. In mathematical formula (1), det represents a determinant, and J represents a Jacobian matrix. When M=3, the Jacobian matrix is defined as mathematical formula (2).

$$\begin{matrix}{p}_{j} = \frac{{q}_{j}}{\vert det \partial {Y}_{j} / \partial θ \vert} = \frac{{q}_{j}}{\vert det {J}_{j} \vert} & ( 1 ) \\ J = \frac{\partial Y}{\partial θ} = \frac{\partial 〈 {y}_{1} , {y}_{2} , {y}_{3} 〉}{\partial 〈 a , c , d 〉} = ( \begin{matrix}\frac{\partial {y}_{1}}{\partial a} & \frac{\partial {y}_{1}}{\partial c} & \frac{\partial {y}_{1}}{\partial d} \\ \frac{\partial {y}_{2}}{\partial a} & \frac{\partial {y}_{2}}{\partial c} & \frac{\partial {y}_{2}}{\partial d} \\ \frac{\partial {y}_{3}}{\partial a} & \frac{\partial {y}_{3}}{\partial c} & \frac{\partial {y}_{3}}{\partial d}\end{matrix} ) & ( 2 )\end{matrix}$$

Next, the machine learning apparatus 100 assumes N prediction performances curves f(x; θⱼ) corresponding to the N parameter vectors e in the data space 57 and calculates N prediction performances yⱼ=f(x₀; θⱼ) corresponding to the desired sample size x₀. The machine learning apparatus 100 uses the occurrence probabilities pⱼ of the N sample point sequences Yⱼ as the weights of the N prediction performances yⱼ. With the N prediction performances yⱼ and the weights pⱼ, a probability distribution of estimated values corresponding to the sample size x₀ is approximated. Importance sampling has consequently been performed on the prediction performances yⱼ with the weights pⱼ. The machine learning apparatus 100 calculates a 95% confidence interval corresponding to the sample size x₀ as (a, b), assuming that the prediction performances whose cumulated weight is 2.5% (weighted 2.5% quantile) and whose cumulated weight is 97.5% (weighted 97.5% quantile) are a and b.

According to the third calculation method, sample point sequences are sampled around the initial prediction performance curve in the data space 55, and weights are calculated by converting the sample point sequences into parameter vectors in the parameter space 56. Next, a probability distribution of estimated values corresponding to the sample size x₀ is approximated in the data space 57. In this way, appropriate parameter vectors are sampled. Thus, it is possible to calculate a confidence interval accurately with a fewer sampling number.

Next, processing performed by the machine learning apparatus 100 will be described.

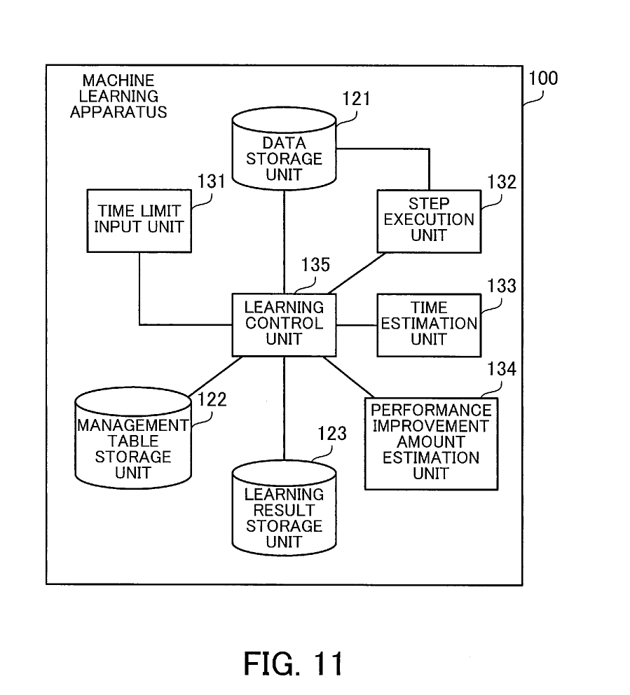

FIG. 11 is a block diagram illustrating a functional example of the machine learning apparatus 100.

The machine learning apparatus 100 includes a data storage unit 121, a management table storage unit 122, a learning result storage unit 123, a time limit input unit 131, a step execution unit 132, a time estimation unit 133, a performance improvement amount estimation unit 134, and a learning control unit 135. For example, each of the data storage unit 121, the management table storage unit 122, and the learning result storage unit 123 is implemented by using a storage area ensured in the RAM 102 or the HDD 103. For example, each of the time limit input unit 131, the step execution unit 132, the time estimation unit 133, the performance improvement amount estimation unit 134, and the learning control unit 135 is implemented by using a program executed by the CPU 101.

The data storage unit 121 holds a data population usable in machine learning. The data population is a population of unit data, and each unit data includes a value of an objective variable (result) and a value of at least one explanatory variable (factor). The machine learning apparatus 100 or a different information processing apparatus may collect the data to be held in the data storage unit 121 from any one of various kinds of device. Alternatively, a user may input the data to the machine learning apparatus 100 or a different information processing apparatus.

The management table storage unit 122 holds a management table for managing the progress of the machine learning. The management table is updated by the learning control unit 135. The management table will be described in detail below.

The learning result storage unit 123 holds results of the machine learning. A result of the machine learning includes a model that indicates a relationship between an objective variable and at least one explanatory variable. For example, a coefficient that indicates the weight of an individual explanatory variable is determined by the machine learning. The result of the machine learning also includes the prediction performance of the learned model. In addition, the result of the machine learning includes information about the machine learning algorithm and the sample size used to learn the model. The information about the machine learning algorithm may include information about a hyperparameter used.

The time limit input unit 131 acquires information about the time limit of the machine learning and notifies the learning control unit 135 of the time limit. The information about the time limit may be inputted by a user via the input device 112. The information about the time limit may be read from a setting file held in the RAM 102 or the HDD 103. The information about the time limit may be received from a different information processing apparatus via the network 114.

The step execution unit 132 executes a plurality of machine learning algorithms. The step execution unit 132 receives a specified machine learning algorithm and sample size from the learning control unit 135. Next, using the data held in the data storage unit 121, the step execution unit 132 executes a learning step in accordance with the specified machine learning algorithm and sample size. Namely, the step execution unit 132 extracts training data and test data from the data storage unit 121 on the basis of the specified sample size. The step execution unit 132 learns a model by using the training data and the specified machine learning algorithm and calculates the prediction performance of the model by using the test data.

When learning a model and calculating the prediction performance thereof, the step execution unit 132 may use any one of various kinds of validation methods such as cross validation or random sub-sampling validation.

The validation method used may previously be set in the step execution unit 132. In addition, the step execution unit 132 measures the execution time of an individual learning step. The step execution unit 132 outputs the model, the prediction performance, and the execution time to the learning control unit 135.

The time estimation unit 133 estimates the execution time of a certain learning step of a certain machine learning algorithm. The time estimation unit 133 receives a specified machine learning algorithm and a specified sample size from the learning control unit 135. Next, the time estimation unit 133 generates an estimation formula for the corresponding execution time from the execution time of at least one executed learning step of the specified machine learning algorithm. The time estimation unit 133 estimates the execution time from the specified sample size and the generated estimation formula. The time estimation unit 133 outputs the estimated execution time to the learning control unit 135.

The performance improvement amount estimation unit 134 estimates the performance improvement amount of a certain learning step of a certain machine learning algorithm. The performance improvement amount estimation unit 134 receives a machine learning algorithm and a sample size from the learning control unit 135. Next, the performance improvement amount estimation unit 134 generates an estimation formula for the corresponding prediction performance from the prediction performance of at least one executed learning step of the specified machine learning algorithm. The performance improvement amount estimation unit 134 estimates the prediction performance from the specified sample size and the generated estimation formula. When estimating this prediction performance, the performance improvement amount estimation unit 134 takes the variation of the prediction performance into consideration and uses a prediction performance larger than the corresponding expected value such as the UCB. The performance improvement amount estimation unit 134 calculates the improvement amount from the currently achieved prediction performance and outputs the improvement amount to the learning control unit 135.

The learning control unit 135 controls machine learning that uses a plurality of machine learning algorithms. The learning control unit 135 causes the step execution unit 132 to execute at least one learning step of each of the plurality of machine learning algorithms. Every time a single learning step is executed, the learning control unit 135 causes the time estimation unit 133 to estimate the execution time of the next learning step of the same machine learning algorithm and causes the performance improvement amount estimation unit 134 to estimate the performance improvement amount of the next learning step. The learning control unit 135 divides the performance improvement amount by the corresponding execution time to calculate the improvement rate.

In addition, the learning control unit 135 selects one of the plurality of machine learning algorithms that indicates the highest improvement rate and causes the step execution unit 132 to execute the next learning step of the selected machine learning algorithm. The learning control unit 135 repeatedly updates the improvement rates and selects a machine learning algorithm until the prediction performance satisfies a predetermined stopping condition or until the learning time exceeds a time limit. Among the models obtained until the machine learning is stopped, the learning control unit 135 stores a model that indicates the highest prediction performance in the learning result storage unit 123. In addition, the learning control unit 135 stores information about the prediction performance, the machine learning algorithm, and the sample size in the learning result storage unit 123.

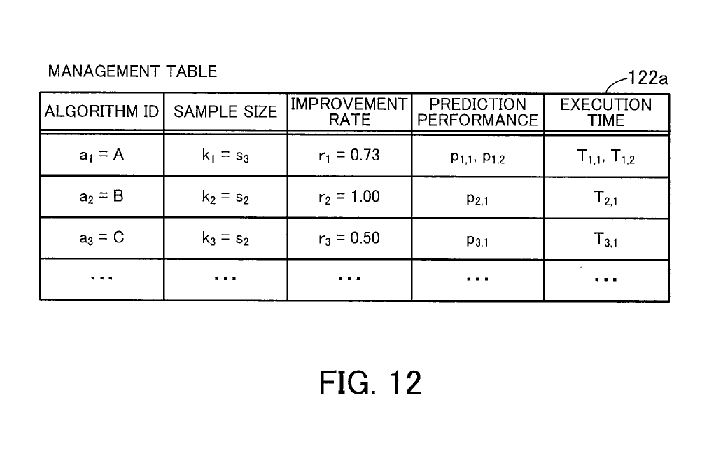

FIG. 12 illustrates an example of a management table.

This management table 122a is generated by the learning control unit 135 and is stored in the management table storage unit 122. The management table 122a includes columns for “algorithm ID”, “sample size”, “improvement rate”, “prediction performance”, and “execution time”.

An individual box under “algorithm ID” represents identification information for identifying a machine learning algorithm. In the following description, the algorithm ID of the i-th machine learning algorithm (i=1, 2, 3, . . . ) will be denoted as aᵢ, as needed. An individual box under “sample size” represents the sample size of the next learning step of a machine learning algorithm. In the following description, the sample size corresponding to the i-th machine learning algorithm will be denoted as kᵢ, as needed.

Step numbers match the sample sizes on a one-on-one basis. In the following description, the sample size of the j-th learning step will be denoted as sⱼ, as needed. Assuming that the data population stored in the data storage unit 121 is denoted by D and the size of the data population D (the number of unit data) is denoted by |D|, for example, s₁ is determined to be |D|/2¹⁰ and sⱼ is determined to be s₁×2^{j-1}.

Per machine learning algorithm, in a box under “improvement rate”, the estimated value of the improvement rate of the next learning step is registered. For example, the unit of the improvement rate is [seconds⁻¹]. In the following description, the improvement rate corresponding to the i-th machine learning algorithm will be denoted as rᵢ, as needed. Per machine learning algorithm, in a box under “prediction performance”, the measured value of the prediction performance of at least one executed learning step is listed. In the following description, the prediction performance calculated in the j-th learning step of the i-th machine learning algorithm will be denoted as p_{i,j}, as needed. Per machine learning algorithm, in a box under “execution time”, the measured value of the execution time of at least one executed learning step is listed. For example, the unit of the execution time is [seconds]. In the following description, the execution time of the j-th learning step of the i-th machine learning algorithm will be denoted as T_{i,j}, as needed.

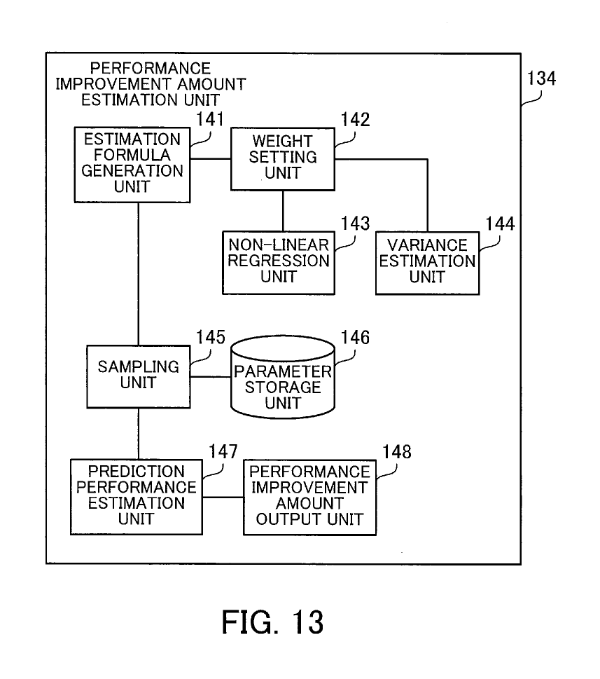

FIG. 13 is a block diagram illustrating a functional example of the performance improvement amount estimation unit.

The performance improvement amount estimation unit 134 includes an estimation formula generation unit 141, a weight setting unit 142, a non-linear regression unit 143, a variance estimation unit 144, a sampling unit 145, the parameter storage unit 146, a prediction performance estimation unit 147, and a performance improvement amount output unit 148.

The estimation formula generation unit 141 estimates, from data X which indicates an execution history of a certain machine learning algorithm, a prediction performance curve that indicates a relationship between sample sizes and prediction performances about this machine learning algorithm. The prediction performance curve is a curve in which the prediction performance asymptotically comes close to a certain limit value as the sample size increase. More specifically, while the sample size is small, the prediction performance exhibits a large increase amount. As the sample size becomes larger, the prediction performance exhibits a smaller increase amount. For example, the prediction performance curve is expressed by a non-linear formula such as y=c−a·x^{-d}. The prediction performance curve generated by the estimation formula generation unit 141 is the most probable and the best prediction performance curve under the data X.

The estimation formula generation unit 141 instructs the weight setting unit 142 to determine the parameter vector θ₀ (θ₀=<a, c, d>) which represents the best prediction performance curve based on the data X. The estimation formula generation unit 141 outputs the determined parameter vector θ₀ to the sampling unit 145.

The weight setting unit 142 sets a weight wⱼ for each sample size xⱼ in the data X used for a non-linear regression analysis. First, the weight setting unit 142 initializes the weight wⱼ to 1. The weight setting unit 142 notifies the non-linear regression unit 143 of the set weight wⱼ and acquires the parameter vector calculated by the non-linear regression analysis from the non-linear regression unit 143. The weight setting unit 142 determines whether the parameter vector <a, c, d> has sufficiently converged.

If the parameter vector <a, c, d> has not sufficiently converged, the weight setting unit 142 notifies the variance estimation unit 144 of the parameter c and acquires the variance VLⱼ corresponding to each sample size xⱼ that is dependent on the parameter c from the variance estimation unit 144. The weight setting unit 142 updates the weight wⱼ by using the variance VLⱼ. Normally, the variance VLⱼ is in inverse proportion to the weight wⱼ. Namely, the larger the variance VLⱼ is, the smaller the weight wⱼ will be. For example, the weight setting unit 142 sets wⱼ=1/VLⱼ. The weight setting unit 142 notifies the non-linear regression unit 143 of the updated weight wⱼ. In this way, until the parameter vector <a, c, d> sufficiently converges, the updating of the weight wⱼ and the parameter c is repeated.

By using the weight wⱼ supplied from the weight setting unit 142, the non-linear regression unit 143 fits <xⱼ, yⱼ> in the data X to the above non-linear formula to determine the parameter vector <a, c, d>. The non-linear regression unit 143 notifies the weight setting unit 142 of the determined parameter vector <a, c, d>. The non-linear regression analysis performed by the non-linear regression unit 143 is a weighted regression analysis. While a relatively large residual error is allowed for a sample size having a small weight, the limit on the residual error is relatively tightened for a sample size having a large weight.

For example, the parameter vector <a, c, d> is determined so that an evaluation value obtained by summing up the products of the weights of the respective sample sizes and the squared residuals is minimized. Thus, priority is given to reducing the residual error of a sample size having a large weight. Normally, since a larger sample size has a larger weight, priority is given to reducing the residual error of a large sample size.

By using the parameter c supplied from the weight setting unit 142, the variance estimation unit 144 estimates the variance VLⱼ corresponding to each sample size xⱼ about the error included in the prediction performance yⱼ in the data X. The variance VLⱼ is calculated from the expected bias EB2 and the expected loss ELⱼ corresponding to the sample size xⱼ. Specifically, VLⱼ=C×(ELⱼ+EB2)×(ELⱼ−EB2). However, since only the ratio among the variances VLⱼ of a plurality of sample sizes is important and the magnitude itself of each variance VL_{A} is not important, the variance estimation unit 144 determines that the constant C is 1, to simplify the calculation. The expected bias EB2 is calculated from the parameter c. The expected loss ELⱼ is calculated from the prediction performance yⱼ The variance estimation unit 144 notifies the weight setting unit 142 of the estimated variance VLⱼ.

The sampling unit 145 stores the parameter vector θ₀ acquired from the estimation formula generation unit 141 in the parameter storage unit 146. In addition, the sampling unit 145 samples N parameter vectors around the parameter vector θ₀, calculates N weights corresponding to these N parameter vectors, and stores the N sets of parameter vectors and weights in the parameter storage unit 146. For example, the number N of samples=9^{M}.

The sampling of the parameter vectors is performed in accordance with the above third calculation method. The sampling unit 145 selects at least M sample sizes in the data space 55. In the data space 55, the sampling unit 145 samples one point per sample size around the prediction performance curve represented by the parameter vector θ₀ and generates a sample point sequence. The sampling unit 145 generates N sample point sequences by repeating this sampling N times. The sampling unit 145 converts the N sample point sequences into N parameter vectors in the parameter space 56. The sampling unit 145 calculates the occurrence probabilities of the parameter vectors in the parameter space 56 and converts the parameter vector occurrence probabilities into the occurrence probabilities of the sample point sequences in the data space 57. In this way, the N parameter vectors and the respective N weights are generated.

The parameter storage unit 146 holds the parameter vector θ₀ determined by the estimation formula generation unit 141. In addition, the parameter storage unit 146 holds the N parameter vectors sampled by the sampling unit 145 and the respective N weights. The parameter vectors and the weights are supplied to the prediction performance estimation unit 147 via the sampling unit 145.

When the performance improvement amount estimation unit 134 calculates a performance improvement amount of a certain machine learning algorithm, there are cases in which the data X used by the machine learning algorithm has not changed since the last time. In this case, the parameter vectors and the weights stored in the parameter storage unit 146 may be used again, without operating the estimation formula generation unit 141 or the sampling unit 145.

The prediction performance estimation unit 147 acquires the N parameter vectors and the respective N weights from the sampling unit 145 and calculates an estimated prediction performance value corresponding to the sample size specified by the learning control unit 135. The estimated value calculated herein is a value larger than the corresponding expected value on the most probable prediction performance curve by the width obtained in view of the variation of the estimated value. For example, the prediction performance estimation unit 147 calculates the upper limit (UCB) of the 95% confidence interval. The prediction performance estimation unit 147 outputs the calculated estimated value to the performance improvement amount output unit 148.

The estimated prediction performance value is calculated in accordance with the above third calculation method. The prediction performance estimation unit 147 assumes the N prediction performances curves corresponding to the sampled N parameter vectors in the data space 57 and calculates the N prediction performances corresponding to the specified sample size. The prediction performance estimation unit 147 deems the calculated N prediction performances and the respective N weights as a probability distribution of estimated values corresponding to the specified sample size. Based on the cumulated weights in which the weights have been cumulated in the ascending order of prediction performance, the prediction performance estimation unit 147 calculates a weighted 2.5% quantile and a weighted 97.5% quantile and determines a 95% confidence interval.

The performance improvement amount output unit 148 acquires an estimated value Up (for example, the UCB) of the prediction performance from the prediction performance estimation unit 147 and calculates a performance improvement amount by subtracting a currently achieved prediction performance P from the acquired estimated value Up. However, when Up−P<0, the performance improvement amount is set to 0. The performance improvement amount output unit 148 outputs the calculated performance improvement amount to the learning control unit 135.

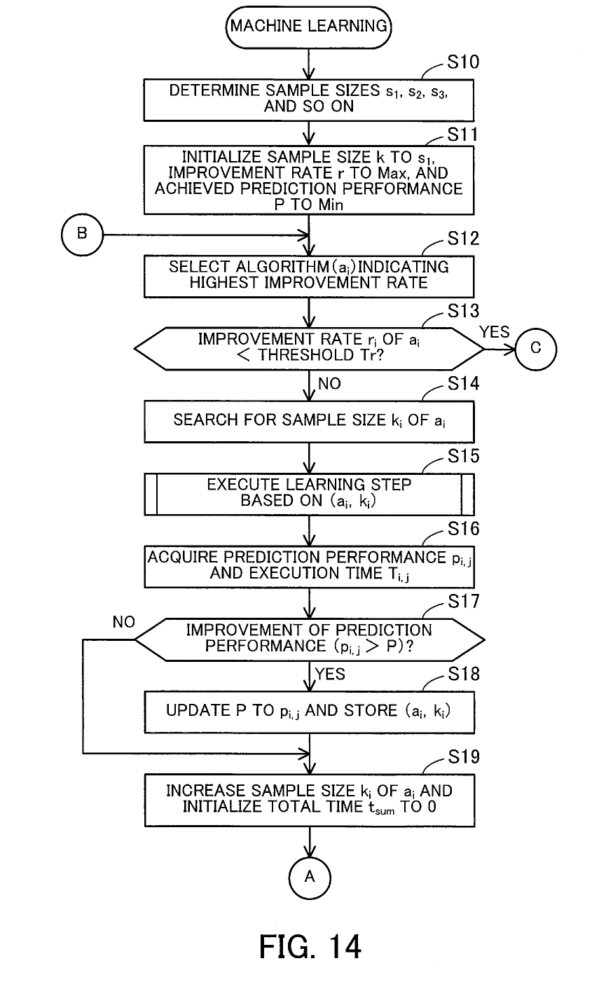

FIG. 14 is the first half of a flowchart illustrating an example of a procedure of machine learning.

(S10) The learning control unit 135 refers to the data storage unit 121 and determines sample sizes s₁, 52, 53, and so on of the learning steps in accordance with progressive sampling. For example, the learning control unit 135 determines that s₁=|D|/2¹⁰ and sⱼ=s₁×2^{j-1} on the basis of the size of the data population D stored in the data storage unit 121.

(S11) The learning control unit 135 initializes the sample size k of an individual machine learning algorithm in the management table 122a to the minimum value s₁. In addition, the learning control unit 135 initializes the improvement rate r of an individual machine learning algorithm to its maximal possible value. In addition, the learning control unit 135 initializes the achieved prediction performance P to its minimum possible value (for example, 0).

(S12) The learning control unit 135 selects a machine learning algorithm that indicates the highest improvement rate from the management table 122a. The following description assumes that a machine learning algorithm aᵢ has been selected.

(S13) The learning control unit 135 determines whether the improvement rate rᵢ of the machine learning algorithm aᵢ is less than a threshold Tr. The threshold Tr may be set in advance by the learning control unit 135. For example, the threshold Tr is 0.001/3,600. If the improvement rate rᵢ is less than the threshold Tr, the operation proceeds to step S28. Otherwise, the operation proceeds to step S14.

(S14) The learning control unit 135 searches the management table 122a for the next sample size kᵢ corresponding to the machine learning algorithm aᵢ.

(S15) The learning control unit 135 specifies the machine learning algorithm aᵢ and the sample size kᵢ to the step execution unit 132. The step execution unit 132 executes the learning step based on the machine learning algorithm aᵢ and the sample size kᵢ. The processing of the step execution unit 132 will be described in detail below.

(S16) The learning control unit 135 acquires the learned model, the prediction performance p_{i,j} thereof, and the execution time T_{i,j} from the step execution unit 132.

(S17) The learning control unit 135 compares the prediction performance p_{i,j} acquired in step S16 with the achieved prediction performance P (the maximum prediction performance achieved up until now) and determines whether the former is larger than the latter. If the prediction performance p_{i,j} is larger than the achieved prediction performance P, the operation proceeds to step S18. Otherwise, the operation proceeds to step S19.

(S18) The learning control unit 135 updates the achieved prediction performance P to the prediction performance p_{i,j}. In addition, the learning control unit 135 stores the machine learning algorithm aᵢ and the sample size kᵢ with which the prediction performance has been obtained, in association with the achieved prediction performance P.

(S19) The learning control unit 135 increases the sample size kᵢ stored in the management table 122a to the next sample size (for example, twice the current sample size). In addition, the learning control unit 135 initializes a total time tₛᵤₘ to 0.

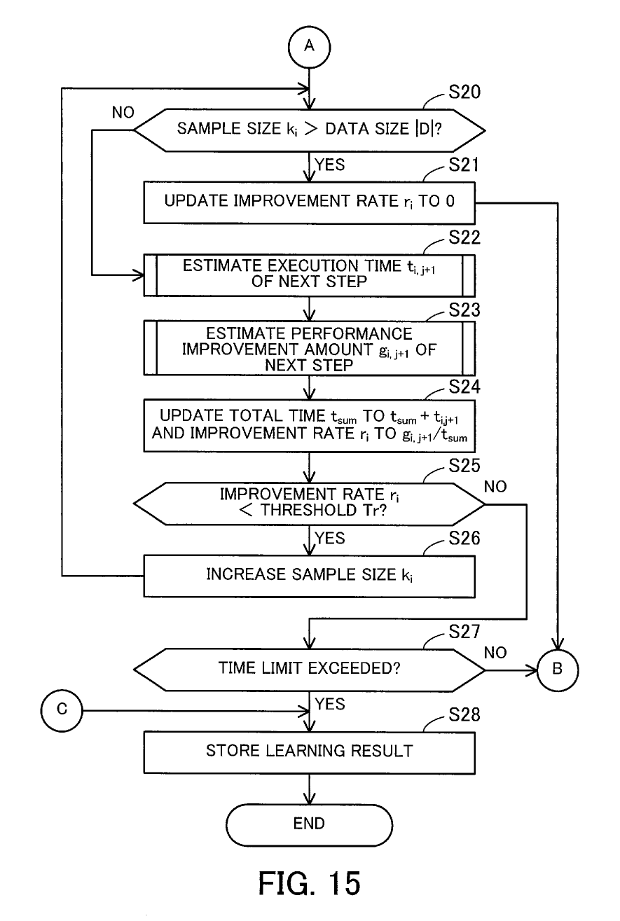

FIG. 15 is the second half of the flowchart illustrating the example of the procedure of the machine learning.

(S20) The learning control unit 135 compares the updated sample size kᵢ of the machine learning algorithm aᵢ with the data size |D| of the data population D stored in the data storage unit 121 and determines whether the former is larger than the latter. If the sample size kᵢ is larger than the data size |D| of the data population D, the operation proceeds to step S21. Otherwise, the operation proceeds to step S22.

(S21) Among the improvement rates stored in the management table 122a, the learning control unit 135 updates the improvement rate rᵢ corresponding to the machine learning algorithm aᵢ to 0. In this way, the machine learning algorithm aᵢ will not be executed. Next, the operation returns to the above step S12.

(S22) The learning control unit 135 specifies the machine learning algorithm aᵢ and the sample size kᵢ to the time estimation unit 133. The time estimation unit 133 estimates an execution time t_{i,j+1} needed when the next learning step of the machine learning algorithm aᵢ is executed based on the sample size kᵢ. The processing of the time estimation unit 133 will be described in detail below.

(S23) The learning control unit 135 specifies the machine learning algorithm aᵢ and the sample size kᵢ to the performance improvement amount estimation unit 134. The performance improvement amount estimation unit 134 estimates a performance improvement amount g_{i,j+1} obtained when the next learning step of the machine learning algorithm aᵢ is executed based on the sample size kᵢ. The processing of the performance improvement amount estimation unit 134 will be described in detail below.

(S24) On the basis of the execution time t_{i,j+1} acquired from the time estimation unit 133, the learning control unit 135 updates the total time tₛᵤₘ to tₛᵤₘ+t_{i,j+1}. In addition, on the basis of the updated total time tₛᵤₘ and the performance improvement amount g_{i,j+1} acquired from the performance improvement amount estimation unit 134, the learning control unit 135 calculates the improvement rate rᵢ (rᵢ=g_{i,j+1}/tₛᵤₘ). The learning control unit 135 updates the improvement rate rᵢ stored in the management table 122a to the above updated value.

(S25) The learning control unit 135 determines whether the improvement rate rᵢ is less than the threshold Tr. If the improvement rate rᵢ is less than the threshold Tr, the operation proceeds to step S26. Otherwise, the operation proceeds to step S27.

(S26) The learning control unit 135 increases the sample size kᵢ to the next sample size. Next, the operation returns to step S20.

(S27) The learning control unit 135 determines whether the time that has elapsed since the start of the machine learning has exceeded the time limit specified by the time limit input unit 131. If the elapsed time has exceeded the time limit, the operation proceeds to step S28. Otherwise, the operation returns to step S12.

(S28) The learning control unit 135 stores the achieved prediction performance P and the model that has achieved the achieved prediction performance P in the learning result storage unit 123. In addition, the learning control unit 135 stores the algorithm ID of the machine learning algorithm associated with the achieved prediction performance P and the sample size associated with the achieved prediction performance P in the learning result storage unit 123. In this step, the hyperparameter set with respect to the machine learning algorithm may also be stored.

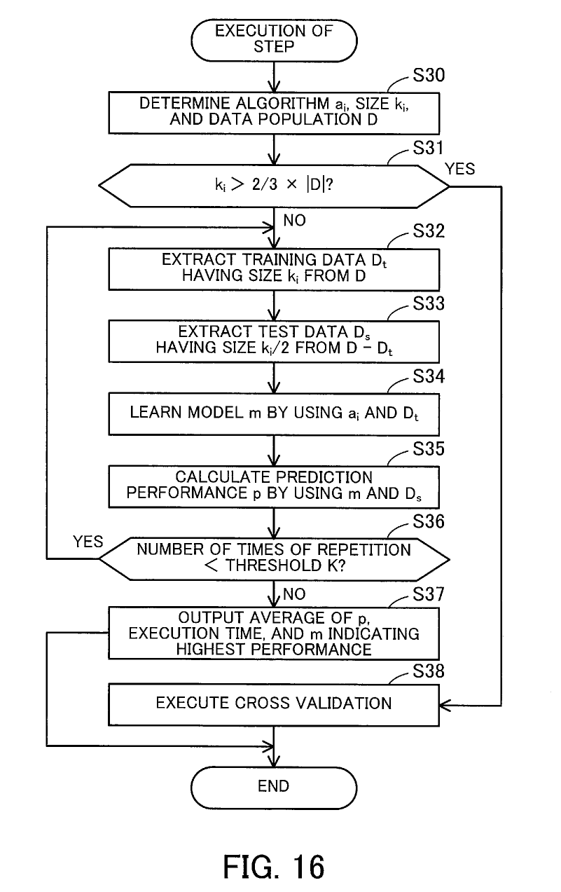

FIG. 16 is a flowchart illustrating an example of a procedure of step execution.

The following description will be made by using a case in which random sub-sampling validation or cross validation is executed as the validation method, depending on the size of the data population D. However, alternatively, the step execution unit 132 may use a different validation method.

(S30) The step execution unit 132 determines the machine learning algorithm aᵢ and the sample size kᵢ=sⱼ₊₁ specified by the learning control unit 135. In addition, the step execution unit 132 determines the data population D stored in the data storage unit 121.

(S31) The step execution unit 132 determines whether the sample size kᵢ is larger than ⅔ of the size of the data population D. If the sample size kᵢ is larger than ⅔×|D|, the step execution unit 132 selects cross validation since the data amount is insufficient. Namely, the operation proceeds to step S38. If the sample size kᵢ is equal to or less than ⅔×|D|, the step execution unit 132 selects random sub-sampling validation since the data amount is sufficient. Namely, the operation proceeds to step S32.

(S32) The step execution unit 132 randomly extracts the training data Dₜ having the sample size kᵢ from the data population D. The extraction of the training data is performed as a sampling operation without replacement. Thus, the training data includes kᵢ unit data different from each other.

(S33) The step execution unit 132 randomly extracts test data Dₛ having a size kᵢ/2 from the portion indicated by (data population D−training data Dₜ). The extraction of the test data is performed as a sampling operation without replacement. Thus, the test data includes kᵢ/2 unit data that is different from the training data Dₜ and that is different from each other. While the ratio between the size of the training data Dₜ and the size of the test data Dₛ is 2:1 in this example, a different ratio may be used.

(S34) The step execution unit 132 learns a model m by using the machine learning algorithm aᵢ and the training data Dₜ extracted from the data population D.

(S35) The step execution unit 132 calculates the prediction performance p of the model m by using the learned model m and the test data Dₛ extracted from the data population D. Any index such as accuracy, precision, an MSE, or an RMSE may be used as the index that represents the prediction performance p. The index that represents the prediction performance p may be set in advance in the step execution unit 132.

(S36) The step execution unit 132 compares the number of times of the repetition of the above steps S32 to S35 with a threshold K and determines whether the former is less than the latter. The threshold K may be previously set in the step execution unit 132. For example, the threshold K is 10. If the number of times of the repetition is less than the threshold K, the operation returns to step S32. Otherwise, the operation proceeds to step S37.

(S37) The step execution unit 132 calculates an average value of the K prediction performances p calculated in step S35 and outputs the average value as a prediction performance p_{i,j}. In addition, the step execution unit 132 calculates and outputs the execution time T_{i,j} needed from the start of step S30 to the end of the repetition of the above steps S32 to S36. In addition, the step execution unit 132 outputs a model that indicates the highest prediction performance p among the K models learned in step S34. In this way, a single learning step with random sub-sampling validation is ended.

(S38) The step execution unit 132 executes the above cross validation, instead of the above random sub-sampling validation. For example, the step execution unit 132 randomly extracts sample data having the sample size kᵢ from the data population D and equally divides the extracted sample data into K blocks. The step execution unit 132 repeats using the (K−1) blocks as the training data and one block as the test data K times while changing the block used as the test data. The step execution unit 132 outputs the average value of the K prediction performances, the execution time, and the model that indicates the highest prediction performance.

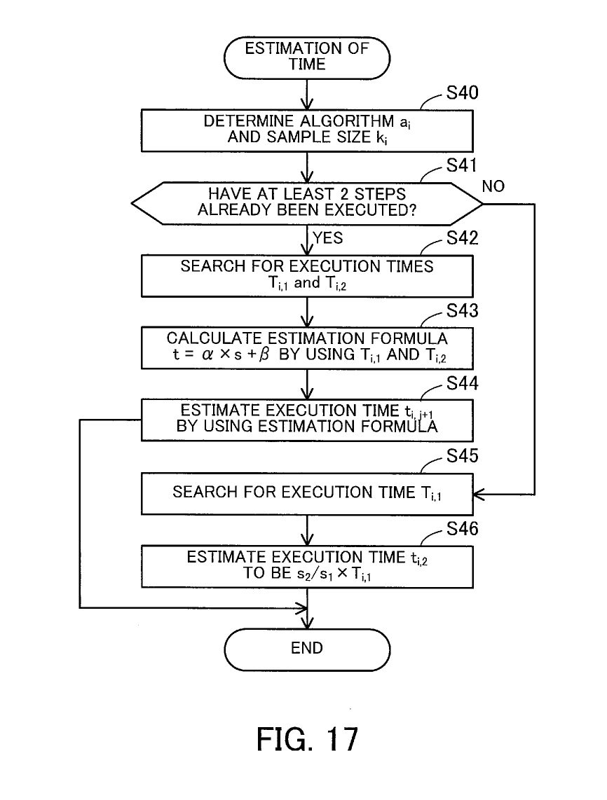

FIG. 17 is a flowchart illustrating an example of a procedure of time estimation.

(S40) The time estimation unit 133 determines the machine learning algorithm aᵢ and the sample size kᵢ=sⱼ₊₁ specified by the learning control unit 135.

(S41) The time estimation unit 133 determines whether at least two learning steps of the machine learning algorithm aᵢ based on different sample sizes have been executed. If at least two learning steps have already been executed, the operation proceeds to step S42. If only one learning step has already been executed, the operation proceeds to step S45.

(S42) The time estimation unit 133 searches the management table 122a for execution times T_{i,1} and T_{i,2} that correspond to the machine learning algorithm aᵢ.

(S43) By using the sample sizes s₁ and s₂ and the execution times T_{i,1} and T_{i,2}, the time estimation unit 133 determines coefficients α and β in an estimation formula t=α×s+β for estimating an execution time t from a sample size s. The coefficients α and β are determined by solving a simultaneous equation formed by a formula in which T_{i,1} and s₁ are assigned to t and s, respectively, and a formula in which T_{i,2} and s₂ are assigned to t and s, respectively. If three or more learning steps of the machine learning algorithm aᵢ have already been executed, the time estimation unit 133 may determine the coefficients α and β through a regression analysis based on the execution times of these learning steps. The present description assumes that the sample size and the execution time are describable by a linear formula.

(S44) The time estimation unit 133 estimates the execution time t_{i,j+1} of the next learning step by using the above execution time estimation formula and sample size kᵢ (by assigning kᵢ to s in the estimation formula). The time estimation unit 133 outputs the estimated execution time t_{i,j+1}.

(S45) The time estimation unit 133 searches the management table 122a for the execution time T_{i,1} that corresponds to the machine learning algorithm aᵢ.

(S46) The time estimation unit 133 estimates the execution time t_{i,2} of the second learning step to be s₂/s₁×T_{i,1} by using the sample sizes s₁ and s₂ and the execution time T_{i,1}. The time estimation unit 133 outputs the estimated execution time t_{i,2}.

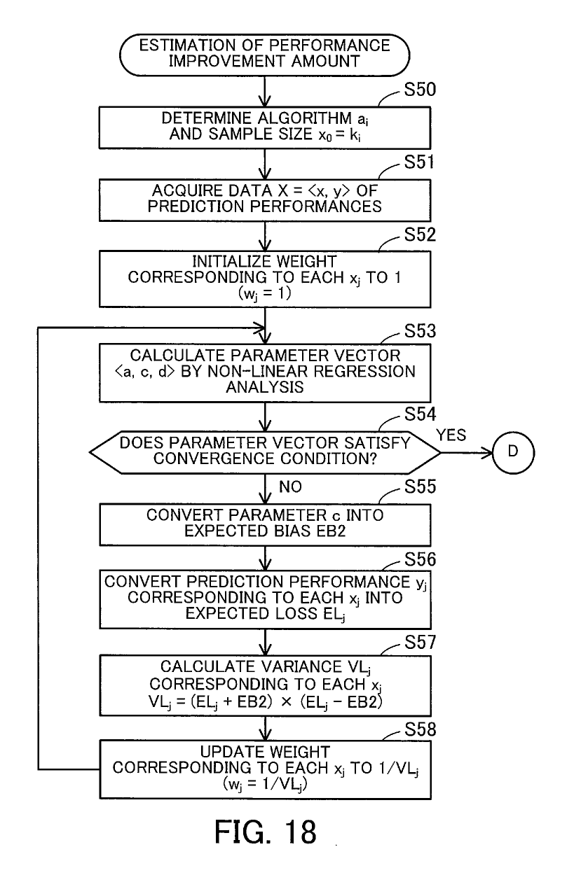

FIG. 18 is the first half of a flowchart illustrating an example of a procedure of estimation of a performance improvement amount.

(S50) The estimation formula generation unit 141 determines the machine learning algorithm aᵢ and the sample size x₀=kᵢ specified by the learning control unit 135.

(S51) The estimation formula generation unit 141 acquires sets of <x, y>, each of which is a combination of a sample size x and a prediction performance y, as data X, which is the measured data of the corresponding prediction performances. The data X signifies training data for learning a prediction performance curve.

(S52) The weight setting unit 142 initializes the weight wⱼ corresponding to each xⱼ to 1 (wⱼ=1).

(S53) By using the data X acquired in step S51, the non-linear regression unit 143 performs a non-linear regression analysis and calculates the parameter vector <a, c, d> in the non-linear formula y=c−a·x^{-d}, wherein the sample size x is the explanatory variable, and the prediction performance y is the objective variable. This non-linear regression analysis is a weighted regression analysis in which the weight wⱼ corresponding to each xⱼ is taken into consideration when the residual error is evaluated. A relatively large residual error is allowed for a sample size having a smaller weight, and the limit on the residual error is relatively tightened for a sample size having a large weight. Different weights may be set among a plurality of sample sizes. In this way, even when homoscedasticity about the prediction performance is not established (heteroscedasticity is established), the reduction in the accuracy of the regression analysis is managed. The above non-linear formula is an example of the estimation formula. Another non-linear formula which indicates a curve in which the prediction performance y asymptotically comes close to a certain limit value as the sample size x increases may be used. The non-linear regression analysis as described above may be executed by using statistical package software, for example.

(S54) The weight setting unit 142 compares the current parameter vector calculated in step S53 with the previous parameter vector and determines whether the parameter vector satisfies a predetermined convergence condition. For example, when the current parameter vector matches the previous parameter vector or when the difference between the two parameter vectors is less than a threshold, the weight setting unit 142 determines that the convergence condition is satisfied. If the parameter vector is calculated for the first time, the weight setting unit 142 determines that the convergence condition has not been satisfied yet. If the convergence condition is not satisfied, the operation proceeds to step S55. If the convergence condition is satisfied, the current parameter vector is determined as θ₀, and the operation proceeds to step S59.

(S55) The variance estimation unit 144 converts the parameter c calculated in step S53 into the expected bias EB2. The parameter c represents the limit of the increase of the prediction performance when the machine learning algorithm aᵢ is used and corresponds to the expected bias EB2. The relationship between the parameter c and the expected bias EB2 is dependent on the index of the prediction performance y. When the prediction performance y is accuracy, EB2=1−c. When the prediction performance y is an MSE, EB2=c. When the prediction performance y is an RMSE, EB2=c².

(S56) The variance estimation unit 144 converts the prediction performance yⱼ corresponding to each sample size xⱼ into the expected loss ELⱼ. The relationship between the measured prediction performance yⱼ and the expected loss ELⱼ is dependent on the index of the prediction performance y. When the prediction performance y is accuracy, ELⱼ=1−yⱼ. When the prediction performance y is an MSE, ELⱼ=yⱼ When the prediction performance y is an RMSE, ELⱼ=yⱼ².

(S57) The variance estimation unit 144 calculates the variance VLⱼ of the prediction performance corresponding to each sample size x by using the expected bias EB2 obtained in step S55 and the expected loss ELⱼ obtained in step S56. VLⱼ=(ELⱼ+EB2)×(ELⱼ−EB2).

(S58) The weight setting unit 142 updates the weight wⱼ corresponding to each xⱼ to 1/VLⱼ (wⱼ=1/VLⱼ). Next, the operation returns to step S53, and a non-linear regression analysis is performed.

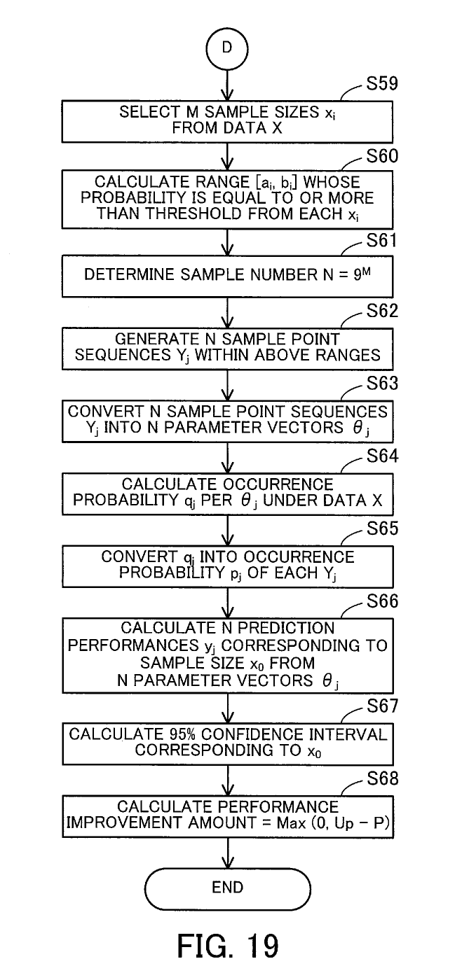

FIG. 19 is the second half of the flowchart illustrating the example of the procedure of the estimation of the performance improvement amount.

(S59) The sampling unit 145 selects M sample sizes xᵢ corresponding to the number of degrees of the parameter vector from the sample sizes included in the data X. For example, when M=3, the sampling unit 145 determines that the 25% and 75% quantiles of the sample sizes included in the data X are x₁ and x₃, respectively, and that the geometric mean of xᵢ and x₃ is x₂.

(S60) For each of the selected sample sizes xᵢ, the sampling unit 145 calculates a range [aᵢ, bᵢ] of the prediction performance centering around the corresponding point on the prediction performance curve indicated by the parameter vector θ₀. In the range, the probability is equal to or more than a threshold (for example, 10⁻⁶). To calculate this range, the error probability density function fₑᵣᵣ(ε, xᵢ, θ₀) is used.

(S61) The sampling unit 145 determines the number of samples N. For example, the sampling unit 145 determines that N=9^{M}, by using the number M of degrees.

(S62) The sampling unit 145 generates a sample point sequence by sampling points one by one from the M ranges calculated in step S60. The sampling unit 145 repeats this sampling N times to generate N sample point sequences Y The generation of the N sample point sequences Yⱼ is performed as uniform sampling.

(S63) The sampling unit 145 converts the N sample point sequences Yⱼ generated in step S62 into N parameter vectors θⱼ. When the number of points included in an individual sample point sequence Yⱼ is equal to the number of degrees of the parameter vector, it is possible to determine a single prediction performance curve that passes through all the points from the individual sample point sequence Yⱼ in principle. The sampling unit 145 may analytically solve the parameter vectors θⱼ by using a mathematical formula such as y=c−a·x^{-d}. Alternatively, the sampling unit 145 may determine the parameter vectors θⱼ by performing a regression analysis. Depending on the sample point sequence, the corresponding parameter vector could not be solved.

(S64) The sampling unit 145 calculates the occurrence probability qⱼ under the data X per parameter vector θⱼ converted in step S63. By using a likelihood function, qⱼ is set to L(θⱼ; X). Alternatively, by using the posterior probability, qⱼ is set to Pₚₒₛₜₑᵣᵢₒᵣ(θⱼ|X). When a parameter vector θⱼ is not solved, qⱼ is set to 0.

(S65) The sampling unit 145 converts the occurrence probabilities qⱼ of the N parameter vectors θⱼ calculated in step S64 into occurrence probabilities pⱼ of the N sample point sequences Yⱼ. The sampling unit 145 calculates the occurrence probabilities pⱼ by using a Jacobian matrix as indicated by the above mathematical formula (1). The sampling unit 145 deems the occurrence probabilities pⱼ as the weights corresponding to the parameter vectors θⱼ. The sampling unit 145 stores the parameter vector θ₀ determined in step S54 in the parameter storage unit 146. The sampling unit 145 also stores the N parameter vectors θⱼ and the respective N weights pⱼ in the parameter storage unit 146.

(S66) The prediction performance estimation unit 147 generates N prediction performance curves from the N parameter vectors θⱼ and the function f(x; θ) of the prediction performance curve and calculates N prediction performances yⱼ=f(x₀; θⱼ) corresponding to the sample size x₀ specified by the learning control unit 135.

(S67) The prediction performance estimation unit 147 generates a probability distribution of estimated values corresponding to the sample size x₀ from the N prediction performances yⱼ calculated in step S66 and the respective N weights pⱼ The prediction performance estimation unit 147 calculates a weighted 2.5% quantile a whose cumulated weight is 2.5% and a weighted 97.5% quantile b whose cumulated weight is 97.5%, the cumulated weight having been obtained by cumulating the weight pⱼ in the ascending order of prediction performance yⱼ. The prediction performance estimation unit 147 determines (a, b) to be a 95% confidence interval.

(S68) The performance improvement amount output unit 148 determines the upper limit (UCB) of the 95% confidence interval calculated in step S67 to be an estimated value Up of the prediction performance corresponding to the sample size x₀. The performance improvement amount output unit 148 acquires the currently achieved prediction performance P and outputs Up−P as the performance improvement amount. However, when Up−P<0, 0 is outputted as the performance improvement amount.

The machine learning apparatus 100 according to the second embodiment estimates, for each of a plurality of machine learning algorithms, the improvement amount of the prediction performance per unit time (improvement rate) when the next learning step using a sample size larger by one level than the last sample size is executed. The machine learning apparatus 100 selects a machine learning algorithm that indicates the highest improvement rate and executes the next learning step of the selected machine learning algorithm. By repeating the estimation of the improvement rate and the selection of the machine learning algorithm, the machine learning apparatus 100 finally outputs a model that indicates the highest prediction performance.

In this way, since the machine learning apparatus 100 does not execute the learning steps that do not contribute to improvement in prediction performance, the overall learning time is shortened. In addition, since the machine learning apparatus 100 selects a machine learning algorithm that indicates the highest estimated improvement rate value, even when the learning time is limited and the machine learning is stopped before its completion, a model obtained when the machine learning is stopped is the best model obtainable within the time limit. In addition, while the learning steps that contribute to improvement in prediction performance (even if the improvement is very little) could be executed later in the execution order, these learning steps could be executed. Thus, the risk of eliminating a machine learning algorithm that could generate a model whose maximum prediction performance is high is reduced when the sample size is small. As described above, the prediction performance of a model is improved efficiently by using a plurality of machine learning algorithms.

In addition, when estimating an improvement rate, instead of an expected value on the most probable prediction performance curve, the machine learning apparatus 100 uses a value (for example, the upper limit of a 95% confidence interval) larger than the expected value in view of an error. In this way, the possibility that the prediction performance exceeds the corresponding expected value is taken into consideration, and the risk of eliminating a machine learning algorithm whose prediction performance is high is reduced.

In addition, when estimating the confidence interval corresponding to a desired sample size, the machine learning apparatus 100 samples sample point sequences around the initial prediction performance curve in a data space, converts the sample point sequences into the parameter vectors in a parameter space, and calculates the respective weights. Next, in a data space, again, the machine learning apparatus 100 estimates a probability distribution of estimated values corresponding to the desired sample size. In this way, even when a prediction performance curve has heteroscedasticity, the confidence interval estimation accuracy is improved. In addition, compared with a case in which parameter vectors are first sampled in a parameter space, appropriate parameter vectors are sampled more easily. Thus, the number of samples is reduced under appropriate estimation accuracy, the computational load is reduced, and the calculation time is shortened.

In one aspect, variance information which indicates variation of a prediction performance is estimated efficiently from a prediction performance curve.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An estimation method comprising:
calculating, by a processor, based on measured data in which a first data size is associated with a prediction performance of a model generated by using training data of the first data size, a first parameter value which defines a first prediction performance curve that indicates a relationship between a data size and a prediction performance,
sampling, by the processor, a prediction performance within a predetermined range from the first prediction performance curve a plurality of times for each of different data sizes, to generate a plurality of sample point sequences, each of which is a sequence of combinations of a data size and a prediction performance,
calculating, by the processor, a plurality of second parameter values which defines a plurality of second prediction performance curves that represents the plurality of sample point sequences and determining a plurality of weights associated with the plurality of second prediction performance curves by using the plurality of second parameter values and the measured data, and
generating, by the processor, variance information which indicates variation of a prediction performance of a second data size estimated from the first prediction performance curve by using the plurality of second prediction performance curves and the plurality of weights.

2. The estimation method according to claim 1, wherein, when a prediction performance for a larger data size is sampled, a smaller width is set to the predetermined range.

3. The estimation method according to claim 1, wherein the determining of a plurality of weights includes calculating a plurality of first occurrence probabilities corresponding to the plurality of second parameter values by using the plurality of second parameter values and the measured data, converting the plurality of first occurrence probabilities into a plurality of second occurrence probabilities corresponding to the plurality of sample point sequences by using the plurality of sample point sequences and the plurality of second parameter values, and determining the plurality of weights from the plurality of second occurrence probabilities.

4. An estimation apparatus comprising:
a memory configured to store measured data in which a first data size is associated with a prediction performance of a model generated by using training data of the first data size; and
a processor configured to execute a process including:
calculating, based on the measured data, a first parameter value which defines a first prediction performance curve that indicates a relationship between a data size and a prediction performance,
sampling a prediction performance within a predetermined range from the first prediction performance curve a plurality of times for each of different data sizes, to generate a plurality of sample point sequences, each of which is a sequence of combinations of a data size and a prediction performance,
calculating a plurality of second parameter values which defines a plurality of second prediction performance curves that represents the plurality of sample point sequences and determining a plurality of weights associated with the plurality of second prediction performance curves by using the plurality of second parameter values and the measured data, and
generating variance information which indicates variation of a prediction performance of a second data size estimated from the first prediction performance curve by using the plurality of second prediction performance curves and the plurality of weights.

5. A non-transitory computer-readable storage medium storing a computer program that causes a computer to execute a process comprising:
calculating, based on measured data in which a first data size is associated with a prediction performance of a model generated by using training data of the first data size, a first parameter value which defines a first prediction performance curve that indicates a relationship between a data size and a prediction performance,
sampling a prediction performance within a predetermined range from the first prediction performance curve a plurality of times for each of different data sizes, to generate a plurality of sample point sequences, each of which is a sequence of combinations of a data size and a prediction performance,
calculating a plurality of second parameter values which defines a plurality of second prediction performance curves that represents the plurality of sample point sequences and determining a plurality of weights associated with the plurality of second prediction performance curves by using the plurality of second parameter values and the measured data, and
generating variance information which indicates variation of a prediction performance of a second data size estimated from the first prediction performance curve by using the plurality of second prediction performance curves and the plurality of weights.
